(19) United States
(12) Patent Application Publication
(10) Pub. No.: US 2024/0182290 A1
(43) Pub. Date: Jun. 6, 2024

(54) INTERIOR COMPONENT FOR CONVEYANCE

(71) Applicant: TS TECH CO., LTD., Asaka-shi, Saitama (JP)

(72) Inventors: Shuichi AKUTSU, Tochigi (JP); Kazuaki MIMA, Tochigi (JP); Ryoichiro TAKEZAWA, Tochigi (JP); Takahiro SHIMIZU, Tochigi (JP); Yuji NAKANO, Tochigi (JP); Takashige II, Tochigi (JP); Yuta OGIWARA, Tochigi (JP)

(21) Appl. No.: 18/551,778

(22) PCT Filed: Mar. 22, 2022
(86) PCT No.: PCT/JP2022/012988

§ 371 Date: Sep. 21, 2023

(30) Foreign Application Priority Data
Mar. 23, 2021 (JP) 2021-049244
Mar. 23, 2021 (JP) 2021-049245
Mar. 23, 2021 (JP) 2021-049246
Mar. 30, 2021 (JP) 2021-058097

(51) Int. Cl. B68G 7/05; B60J 5/04

(52) U.S. Cl. CPC B68G 7/05; B60J 5/0463

(57) ABSTRACT

An interior component for a conveyance having a design surface includes a base material and a skin material covering the base material. The skin material includes linear locking members at end portions of the skin material, and the linear locking members are attached at positions that are not visible from a design surface side of the base material. Since the linear locking members are provided at the end portions of the skin material, the skin material is linearly pulled, so that slack wrinkles of the skin material can be suppressed when the base material is covered with the skin material. In addition, since the linear locking member is attached at a position that is not visible from the design surface side, the skin material can be fixed without using an adhesive agent.

### TECHNICAL FIELD

The present invention relates to an interior component for a conveyance, particularly to an interior component for a conveyance, which is covered with a skin.

### BACKGROUND ART

In the related art, an interior component for a vehicle such as a door armrest includes a base material and a skin material covering the surface of the base material. The skin material is made of, for example, a sheet-shaped soft material. The skin material is attached by winding the skin material at an outer peripheral terminal of the base material and by applying an adhesive agent to the skin material.

PATENT LITERATURE 1 discloses a structure in which a plurality of locking pieces are provided inside a core material, a peripheral end portion of a skin material is folded at an end portion of the core material, and engagement holes formed at the end portion of the skin material are engaged with the locking pieces, so that the skin material is held by the core material.

However, when a sheet-shaped soft material that is not injection-molded is used as a skin to cover a base material of an interior member, slack wrinkles occur or the end portion of the skin material comes off from the locking pieces, which is a risk. For this reason, when the skin material such as a sheet-shaped soft material is fixed to the base material, an adhesive agent is still used or multi-point fixation is performed using a tucker or the like, and a skin terminal is wound and fixed.

### CITATION LIST

### Patent Literature

PATENT LITERATURE 1: JP 2003-312346 A

### SUMMARY OF INVENTION

### Technical Problem

When fixation is performed by a winding method using an adhesive agent, a lot of difficult work by a worker and a lot of man-hours are required. In addition, since a step of applying the adhesive agent is also added, reducing man-hours has been difficult. For this reason, there has been a demand for a structure in which the work process or man-hours are improved by lowering the difficulty of manual work and by making it easier to cover with the skin material through eliminating the use of the adhesive agent or through stopping to wind the skin terminal using a tucker or the like.

The present invention has been made in view of the foregoing problems, and provides an interior component for a conveyance in which workability when covering a base material with a skin is improved and facilitated and in which the work process or man-hours are reduced.

### Solution To Problem

The foregoing problems are solved by an interior component for a conveyance having a design surface according to the present invention, the component including: a base material; and a skin material covering the base material. The skin material includes a linear locking member at an end portion of the skin material, and the linear locking member is attached at a position that is not visible from a design surface side of the base material.

Since the skin material includes the linear locking member at the end portion, the skin material is linearly pulled, so that slack wrinkles of the skin material can be suppressed when the base material is covered with the skin material. In addition, since the linear locking member is attached at a position that is not visible from the design surface side, for example, to a back side of the base material, the skin material can be fixed without using an adhesive agent. Since an adhesive agent is not used, it is possible to provide the interior component for a conveyance in which workability when covering the base material with the skin material is improved and facilitated and in which the work process or man-hours are reduced. Since slack wrinkles are suppressed, variations in the aesthetic finish of the product caused by a worker are reduced, so that the appearance quality is improved and stabilized. The undulation of a design line such as a stitch provided on the skin material is suppressed.

In addition, in the interior component for a conveyance, the linear locking member may be formed in a rod shape or an elongated plate shape.

Since the structure of the linear locking member is simplified, the linear locking member can easily engage with the base material. In addition, since the structure is simple, slack wrinkles of the skin material can be suppressed.

In addition, in the interior component for a conveyance, the linear locking member may include a first linear locking member attached to a first terminal portion of the base material, and a second linear locking member attached to a second terminal portion of the base material, the second terminal portion being located opposite to the first terminal portion.

Since the linear locking members located opposite to each other are attached, the skin material is linearly pulled in opposite directions, so that slack wrinkles of the skin material can be further suppressed.

In addition, in this configuration, the first linear locking member and the second linear locking member may be disposed to be separated from each other as the first linear locking member and the second linear locking member extend from an end portion toward a center of the base material.

The covering skin material is locked in a well-balanced manner according to the shape of the interior component for a conveyance, so that slack wrinkles can be suppressed.

In addition, in the interior component for a conveyance, the first linear locking member may be attached to the first terminal portion on an upper side of the base material, the second linear locking member may be attached to the second terminal portion on a lower side of the base material, and the second linear locking member may be longer than the first linear locking member.

Since the second linear locking member on the lower side is set to be longer than the first linear locking member, the covering the skin material is locked in a well-balanced manner, so that slack wrinkles of the skin material can be suppressed.

In addition, in the interior component for a conveyance, the first linear locking member may be attached to the first terminal portion on an upper side of the base material, and the second linear locking member may be attached to the second terminal portion on a lower side of the base material. The skin material may have a design line between the first linear locking member and the second linear locking member.

Since the first linear locking member and the second linear locking member are attached above and below the design line, the undulation and distortion of the design line are suppressed, so that the appearance merchantability is improved.

In addition, in the interior component for a conveyance, the base material may include an engaging portion that engages with the linear locking member, on a back side of a terminal portion.

Since the engaging portion that engages with the linear locking member is provided, slack wrinkles of the skin material covering the base material can be suppressed.

In addition, in the interior component for a conveyance, the base material may include a point-shaped locking portion that locks the skin material, in addition to the engaging portion.

Since the point-shaped locking portion is provided in addition to the engaging portion, slack wrinkles of the skin material covering the base material can be further suppressed.

In addition, in the interior component for a conveyance, a through-hole may be formed in the vicinity of the end portion of the skin material. The engaging portion may include a hook portion that is hooked onto the linear locking member. The linear locking member may be attached to the base material by being hooked onto the hook portion inserted into the through-hole.

Since the linear locking member is attached to the base material using the hook portion inserted into the through-hole, slack wrinkles of the skin material covering the base material can be further suppressed.

In addition, in the interior component for a conveyance, the engaging portion may include a locking claw that locks the linear locking member. The linear locking member may be formed in an elongated plate shape. The linear locking member may be attached to the base material by being disposed on a back surface side of the base material and by engaging with the locking claw.

Since the linear locking member having a plate shape is engaged with the locking claw, locking can be easily performed with a simple structure.

### Advantageous Effects Of Invention

According to the present invention, since the skin material includes the linear locking member at the end portion, the skin material is linearly pulled, so that slack wrinkles of the skin material can be suppressed when the base material is covered with the skin material. In addition, since the terminal of the skin is attached at a position that is not visible from the design surface side, for example, to the back side of the base material using the linear locking member, the skin material can be fixed without using an adhesive agent. Since an adhesive agent is not used, it is possible to provide the interior component for a conveyance in which workability when covering the base material with the skin material is improved and facilitated and in which the work process or man-hours are reduced. Since slack wrinkles are suppressed, variations in the aesthetic finish of the product caused by a worker are reduced, so that the appearance quality is improved and stabilized. The undulation of the design line such as a stitch provided on the skin material is suppressed.

In addition, since the structure of the linear locking member is simplified, the linear locking member can easily engage with the base material. In addition, since the structure is simple, slack wrinkles of the skin material can be suppressed.

In addition, since the linear locking members located opposite to each other are attached, the skin material is linearly pulled in opposite directions, so that slack wrinkles of the skin material can be further suppressed.

In addition, since the linear locking members located opposite to each other are attached, the skin material is linearly pulled in opposite directions, so that slack wrinkles of the skin material can be further suppressed.

In addition, since the second linear locking member on the lower side is set to be longer than the first linear locking member, slack wrinkles of the skin material can be suppressed.

In addition, since the first linear locking member and the second linear locking member are attached above and below the design line, the undulation and distortion of the design line are suppressed, so that the appearance merchantability is improved.

In addition, since the engaging portion is provided, slack wrinkles of the skin material covering the base material can be suppressed.

In addition, since the point-shaped locking portion is provided, slack wrinkles of the skin material covering the base material can be further suppressed.

In addition, since the linear locking member is attached to the base material using the hook portion inserted into the through-hole, slack wrinkles of the skin material covering the base material can be further suppressed.

In addition, since the linear locking member having a plate shape is engaged with the locking claw, locking can be easily performed with a simple structure.

### BRIEF DESCRIPTION OF DRAWINGS

FIG. 1 is a side view showing a vehicle door including an interior component for a vehicle according to a first embodiment of the present invention.

FIG. 2 is a side view showing an armrest provided on the vehicle door.

FIG. 3 is a cross-sectional view of the armrest taken along line III-III of FIG. 2.

FIG. 4 is an enlarged view showing a portion A of FIG. 3 in an enlarged manner.

FIG. 5 is an enlarged view showing a portion B of FIG. 3 in an enlarged manner.

FIG. 6 is a cross-sectional view showing another example of a linear locking member.

FIG. 7A is a cross-sectional view showing another example of the linear locking member.

FIG. 7B is a front view showing another example of the linear locking member.

FIG. 8 is an explanatory view showing a procedure for attaching the linear locking member.

FIG. 9 is a cross-sectional view showing another example of the linear locking member.

FIG. 10 is a cross-sectional view showing another example of the linear locking member.

FIG. 11 is a perspective view of a vehicle seat according to a second embodiment.

FIG. 12 is a perspective view showing a frame of the vehicle seat according to the second embodiment.

FIG. 13 is a bottom view of a seat cushion of the vehicle seat.

FIG. 14 is a view in which a skin covering the seat cushion is unfolded.

FIG. 15 is a view of the cushion of the vehicle seat when viewed from the side.

FIG. 16 is a cross-sectional view along line XVI-XVI of FIG. 11.

FIG. 17A is a view showing the shape of an opening portion.

FIG. 17B is a view showing a state where a skin is pulled and an end portion is displaced.

FIG. 18A is a view showing another example of the opening portion.

FIG. 18B is a view showing a state where a skin is pulled and an end portion is displaced.

FIG. 19A is a view showing another example of the opening portion.

FIG. 19B is a view showing another example of the opening portion.

FIG. 19C is a view showing a cross section of the opening portion.

FIG. 19D is a view showing another example of the opening portion.

FIG. 19E is a view showing another example of the opening portion.

FIG. 19F is a view showing another example of the opening portion.

FIG. 20A is an explanatory view explaining a method for attaching the end portion of the skin.

FIG. 20B is an explanatory view explaining another method for attaching the end portion of the skin.

FIG. 21 is a flowchart explaining a method for attaching the skin.

FIG. 22 is a view showing another example of the frame engaging member.

### DESCRIPTION OF EMBODIMENTS

### First Embodiment

Hereinafter, a configuration of an interior component for a conveyance according to a first embodiment of the present invention will be described with reference to the drawings. However, the embodiments to be described below are provided to facilitate understanding of the present invention, and does not limit the present invention. Namely, the present invention can be modified and improved without departing from the concept of the present invention, and it goes without saying that the present invention includes equivalents of the present invention.

In addition, in the following description, the contents relating to the material, shape, and size of the interior component for a conveyance are provided as merely one specific example, and do not limit the present invention.

Incidentally, hereinafter, a door lining 50 provided on a vehicle door D, particularly an armrest 1 is provided as one example of the interior component for a conveyance, and a configuration example of the armrest 1 will be described. However, the present invention is not limited to the door lining 50 mounted in ground traveling conveyances including wheels, such as an automobile and a train, and can also be applied to, for example, interior components mounted in an aircraft, a ship, or the like moving in environments other than the ground.

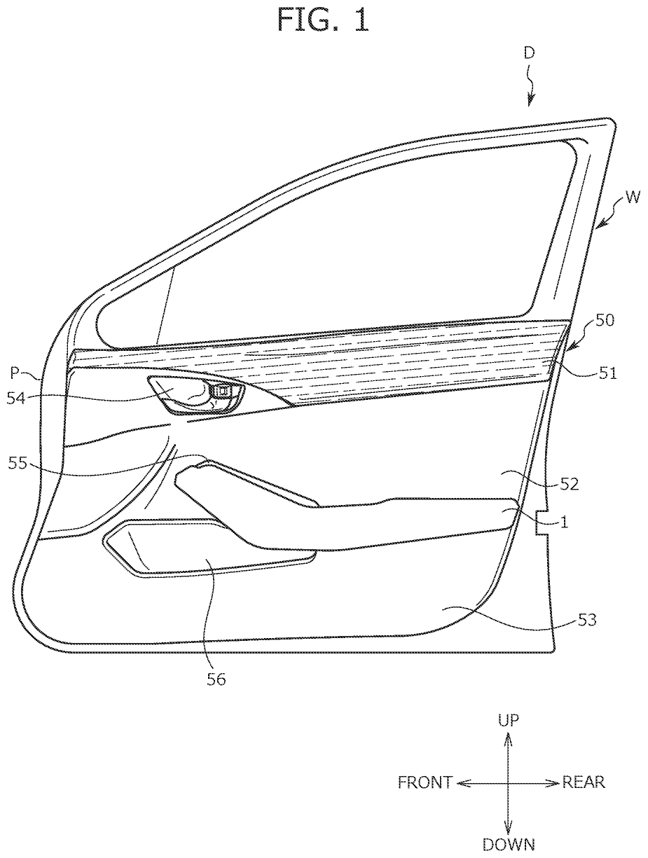

In addition, in the following description, a “front to rear direction” is the front to rear direction of the vehicle door D, and is a direction coinciding with the forward movement direction of a vehicle when traveling. Namely, as shown in FIG. 1, the traveling direction of the vehicle is referred to as a front side, and the opposite side is referred to as a rear side. In addition, an “up to down direction” is the up to down direction of the vehicle door D, and is a direction coinciding with a vertical direction when the vehicle travels on a horizontal surface. In addition, an “outer side” being simply referred to indicates a direction from the center of a cabin toward the outside, the cabin being provided with the vehicle door D, and an “inner side” being referred to means a direction from the outside of the vehicle toward the center of the cabin. The “width direction of the door” is the same as the width direction of the vehicle, and means a direction from the inner side to the outer side of the vehicle door D.

Incidentally, in the following description, unless otherwise specified, the shape, position, posture, and the like of each portion of the vehicle door D and the door lining 50 will be described based on the assumption that the vehicle door is in a closed state.

### Vehicle Door

A basic configuration of the vehicle door D including the door lining 50 according to the first embodiment will be described with reference to FIG. 1. FIG. 1 is a side view showing the door lining 50 provided on the vehicle door D.

The vehicle door D includes a door panel P; a window W formed at an upper portion of the door panel P, and the door lining 50 provided below the window W in the door panel P. The door lining 50 includes an upper member 51; a center member 52; a lower member 53; and the armrest 1 protruding toward the inside of the cabin between the center member 52 and the lower member 53. In addition, a door handle 54 is provided in front of the center member 52, and a door pocket 56 is provided in front of the lower member 53.

### Armrest

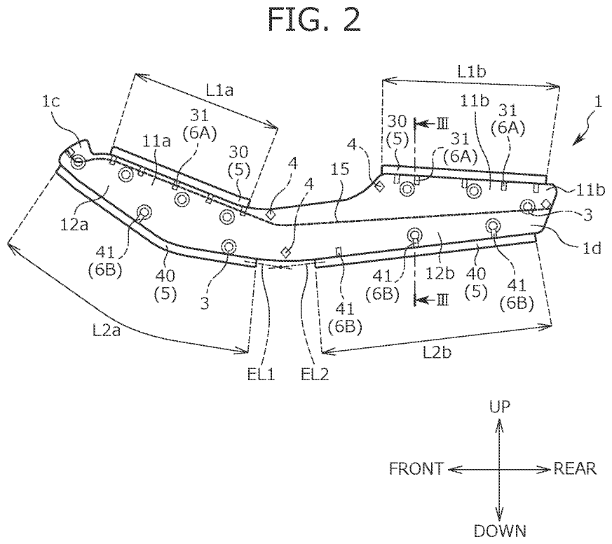

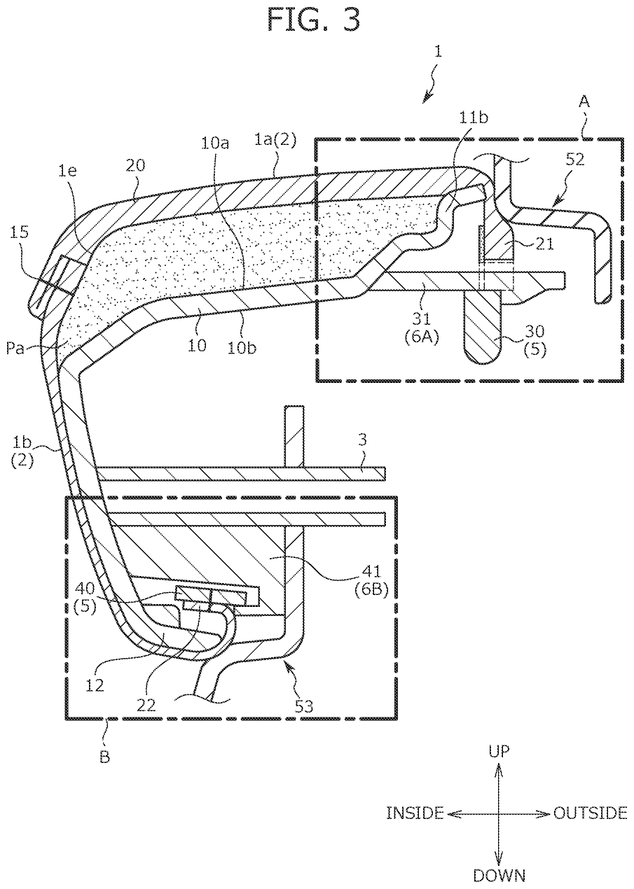

Next, the armrest 1 of the door lining 50 will be described. The armrest 1 is one example of the interior component for a conveyance. FIG. 2 is a side view of the armrest 1 when viewed from the inside of the vehicle, and FIG. 3 is a cross-sectional view of the armrest 1. The armrest 1 is a member protruding toward an interior side as shown in FIGS. 2 and 3, and is a portion on which the hand or arm of an occupant seated in a vehicle seat rests. The armrest 1 has a shape extending in the front to rear direction of the vehicle door D, and an opening and closing switch 55 for opening and closing a power window is provided on an upper surface of the armrest 1 (refer to FIG. 1).

The armrest 1 is attached to the center member 52 and the lower member 53, and externally has a design surface 2 that can be visually recognized by the occupant. Specifically, a surface protruding toward the interior side is the design surface 2. A plurality of bosses 3 are provided on a back surface of the armrest 1 which is not visible from a design surface side, and can connect the center member 52 and the lower member 53.

The armrest 1 includes a base material 10 for maintaining the protruding shape. In addition, the armrest 1 includes a skin material 20 covering a surface 10a on the design surface 2 side of the base material 10 as shown in FIG. 3. The base material 10 is made of resin, and the skin material 20 covering the base material 10 is made of, for example, a fabric, synthetic leather, genuine leather, or the like. The skin material may be made of a nonwoven fabric, film, or the like. In addition, a pad Pa may be disposed between the base material 10 and the skin material 20.

### Design Line

The armrest 1 has an upper surface la on which the hand or arm of the occupant rests, and a side surface 1b, and at a boundary portion between the upper surface 1a and the side surface 1b, a stitch 15 is formed by sewing on the skin material 20 as a design line. An intersection portion le extending in the front to rear direction is formed at a position where the upper surface la and the side surface 1b of the armrest 1 intersect each other, and as shown in FIG. 2, the stitch 15 is disposed linearly along the intersection portion le from a front end 1c to a rear end 1d of the armrest 1.

In addition, the intersection portion le is formed as an inclined surface that is formed flat as shown in FIG. 3. However, this configuration is one example, and the stitched portion on a back side of the skin material 20 may protrude depending on a method for creating the stitch 15. In that case, a recess extending along the intersection portion le may be formed and the protruding portion of the stitch 15 may be inserted into the recess. In addition, since the stitch 15 is intended for design purposes, the stitch 15 may not be provided on the skin material 20.

Incidentally, as the design line of the present embodiment, the stitch 15 is provided by sewing as an accent line; however, the design line is one example, and on the surface of the skin material 20, a pattern may be printed or an embossed pattern may be created by transfer.

### Linear Locking Member

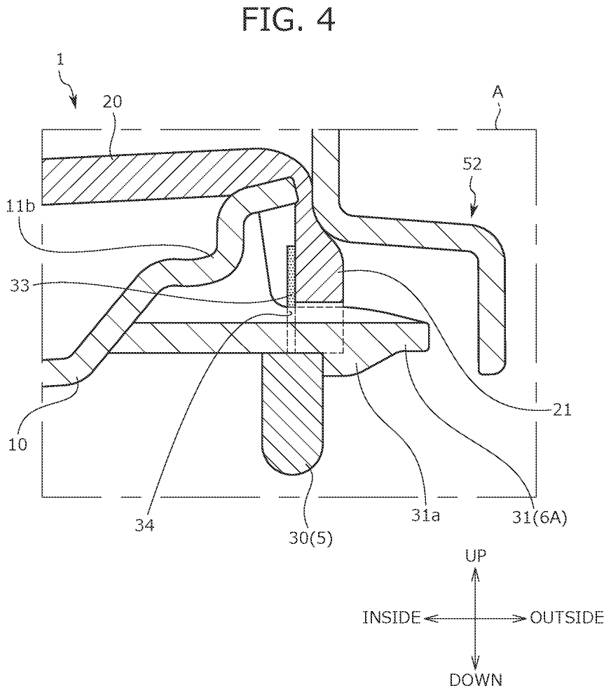

As shown in FIGS. 3 and 4, at an upper end portion 21 of the skin material 20, linear locking members 5 formed in a linear shape are provided according to the shapes of upper terminal portions 11a and 11b of the base material 10.

In the present embodiment, at the upper end portion 21 of the skin material 20, suspender cords 30 (first linear locking members) formed in a rod shape are provided as the linear locking members 5 via a nonwoven fabric 33. In addition, two suspender cords 30 are disposed along the upper end portion 21 of the skin material 20.

The cross-sectional shape of the suspender cords 30 shown in FIGS. 3 and 4 is a shape in which a quadrilateral shape and a semicircular shape are combined; however, the cross-sectional shape of the suspender cords 30 is not limited to this shape, and may be a quadrilateral shape or circular shape.

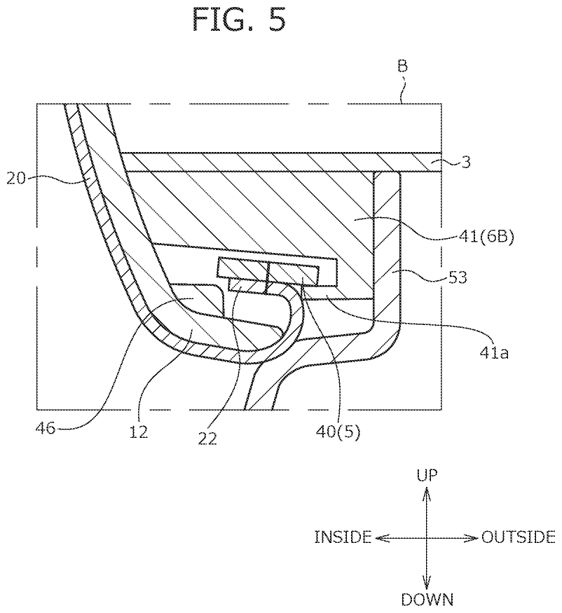

In addition, as shown in FIGS. 3 and 5, at a lower end portion 22 of the skin material 20, the linear locking members 5 formed in a linear shape are also provided according to the shapes of lower terminal portions 12a and 12b of the base material 10.

In the present embodiment, at the lower end portion 22 of the skin material 20, trim cords 40 (second linear locking members) formed in an elongated plate shape are provided as the linear locking members 5 by sewing. The trim cords 40 are formed with the same cross-sectional shape at any portion. The trim cords 40 are disposed to extend along the lower end portion 22 of the skin material 20. As shown in FIGS. 2 and 3, the trim cords 40 are provided at positions facing the suspender cords 30, in other words, at an end portion opposite to the suspender cords 30 (lower end portion 22).

Incidentally, the suspender cords 30 may be used as the linear locking members 5 attached to the lower terminal portions 12a and 12b.

The suspender cords 30 and the trim cords 40 that are the linear locking members 5 provided on the skin material 20 are attached at positions that are not visible from the design surface side of the base material 10. Incidentally, in FIG. 2, the suspender cords 30 and the trim cords 40 are depicted by solid lines for convenience in indicating the positions thereof; however, as shown in FIG. 3, the suspender cords 30 and the trim cords 40 are disposed on a back surface 10b side of the base material 10, which is located at a position that is not visible from the design surface side.

### Engaging Portion

Hereinafter, engaging portions 6 that are provided on the base material 10 to attach the linear locking members 5 to the base material 10 and that engage with the linear locking members 5 will be described. In the present embodiment, there are two types of the engaging portions 6, the engaging portions 6 provided at the upper terminal portions 11a and 11b are engaging portions 6A, and the engaging portions 6 provided at the lower terminal portions 12a and 12b are engaging portions 6B.

As shown in FIG. 2, a plurality of the engaging portions 6A that engage with the suspender cords 30 which are the linear locking members 5 are provided side by side at positions that are not visible from the design surface side of the base material 10, for example, at the upper terminal portions 11a and 11b on the back surface side of the base material 10.

As shown in FIGS. 3 and 4, the engaging portions 6A that engage with the suspender cords 30 protrude in an outward direction of the door, and are provided as hook portions 31 including return portions 31a at tips.

Through-holes 34 through which the hook portions 31 pass are formed in base portions (nonwoven fabric 33) of the suspender cords 30. By causing the hook portions 31 to pass through the through-holes 34 and by the hooking the return portions 31a of the hook portions 31 onto the suspender cords 30, the upper end portion 21 of the skin material 20 is attached at positions that are not visible from the design surface side of the base material 10 (terminal portions on the back surface side).

Incidentally, the spacings at which the hook portions 31 and the through-holes 34 are disposed can be appropriately and arbitrarily adjusted and set.

A plurality of the engaging portions 6B that engage with the trim cords 40 which are the linear locking members 5 are disposed side by side at the lower terminal portions 12a and 12b of the base material 10.

As shown in FIGS. 3 and 5, the engaging portions 6B may be provided as locking claws 41 supported on the bosses 3. The locking claws 41 are provided with return portions 41a. The trim cords 40 are wound at the lower terminal portions 12a and 12b of the base material 10 and are inserted into gaps between ribs 46 and the return portions 41a. The trim cords 40 are fixed by hooking side portions of the trim cords 40 onto the return portions 41a. For this reason, the coming off of the trim cords 40 from the locking claws 41 becomes difficult. In addition, the gaps between the ribs 46 and the return portions 41a of the locking claws 41 can be appropriately set to any size according to the specifications of the skin material 20.

In such a manner, since the suspender cords 30 and the trim cords 40 are engaged with the plurality of engaging portions 6A and 6B provided on the base material 10 and are disposed at positions facing each other, the skin material 20 can be attached while linearly pulling the skin material 20 in opposite directions.

In the present embodiment, the skin material 20 covers and is attached to the base material 10 using a total of four linear locking members 5 on upper and lower sides; however, the number of the linear locking members 5 is changed depending on the shape of the base material 10. When the base material 10 has a simple quadrilateral shape, one linear locking member 5 may be provided on each of the upper and lower sides of the skin material 20, and the skin material 20 may be attached. When the base material 10 has a more complicated shape, the linear locking members 5 are attached according to the number of sides of the base material 10. There is no need to provide the same number of linear locking members 5 on both the upper and lower sides, and the skin material may be attached using different numbers of linear locking members 5.

In such a manner, since the linear locking members 5 having a rod shape or an elongated plate shape are provided at the end portions of the skin material 20, and the skin material 20 is attached to the base material 10, the skin material 20 can be linearly pulled, so that slack wrinkles are suppressed. For this reason, the skin material 20 can be attached to the base material 10 without using an adhesive agent. Since an adhesive agent is not used, workability when covering the base material with the skin material is improved and facilitated. Accordingly, the work process or man-hours are reduced.

Since the skin material 20 is attached to the base material 10 without using an adhesive agent, the need for equipment of the related art for using the adhesive agent is eliminated. For example, the need for an application booth used for applying an adhesive agent, a drying furnace for drying the adhesive agent, crimp molds, press molds, jigs, and the like is eliminated, so that an equipment and work space can be reduced. The work process is simplified and the winding work of the skin material 20 is facilitated, so that the work man-hours can be reduced. Correction work is also suppressed. The misalignment and undulation of the stitch 15 that is a design line are also suppressed, so that the aesthetic finish of the appearance of the product can also be improved and stabilized. Since the local stretching of the skin material is suppressed, the expansion rate of the skin material is substantially uniform, and the flow of the leather grain and the like is suppressed, so that the appearance merchantability can also be improved.

### Disposition and Length of Linear Locking Member

As shown in FIG. 2, the suspender cord 30 and the trim cord 40 disposed on the front side of the armrest 1 are disposed such that the distance between the suspender cord 30 and the trim cord 40 increases from the front end 1c toward the center of the armrest 1 to correspond to the shape of the armrest 1. Namely, the suspender cord 30 and the trim cord 40 are disposed in an inverted V shape.

In addition, the trim cords 40 disposed in the front and rear of the armrest 1 are disposed such that an extension overhead line EL1 extending from the trim cord 40 on the front side and an extension overhead line EL2 extending from the trim cord 40 on the rear side intersect each other at the center of the armrest 1.

In addition, the suspender cord 30 and the trim cord 40 disposed on the rear side are disposed in an inverted V shape such that the distance between the suspender cord 30 and the trim cord 40 increases from the rear end 1d toward the center of the armrest 1.

In such a manner, since the suspender cords 30 and the trim cords 40 are disposed, the covering skin material 20 is locked in a well-balanced manner, so that slack wrinkles can be suppressed.

Incidentally, the suspender cord 30 and the trim cord 40 may be disposed such that the distance therebetween decreases from the front end 1c or the rear end 1d toward the center. In this case, the suspender cord 30 and the trim cord 40 are disposed to intersect each other at a central portion of the armrest 1.

In addition, lengths L1a and L1b of the suspender cords 30 attached to the upper terminal portions 11a and 11b (first terminal portions) on the upper side of the base material 10 are formed to be longer than lengths L2a and L2b of the trim cords 40 attached to the lower terminal portions 12a and 12b (second terminal portions).

By locking the suspender cords 30 and the trim cords 40 in a well-balanced manner according to the shape of the armrest 1, slack wrinkles can be suppressed.

### Relationship Between Design Line and Skin Material

As described above, the stitch 15 is formed as a design line on the surface of the skin material 20. The stitch 15 is provided between the suspender cords 30 and the trim cords 40.

Since the stitch 15 is provided between the suspender cords 30 and the trim cords 40 that are the linear locking members 5, the undulation and distortion of the stitch 15 are suppressed, so that the appearance merchantability is improved.

In addition, when the base material 10 is covered with the skin material 20, the stitch 15 may be positioned by covering the base material 10 with reference to the upper terminal portions 11a and 11b or the lower terminal portions 12a and 12b of the base material 10. Specifically, the trim cords 40 are attached to the engaging portions 6B of the lower terminal portions 12a and 12b, the stitch 15 located at an intermediate portion is pressed against the base material 10, and the suspender cords 30 are fixed to the engaging portions 6A (hook portions 31) of the upper terminal portions 11a and 11b. The suspender cords 30 may be attached to the engaging portions 6A of the upper terminal portions 11a and 11b, the stitch 15 located at the intermediate portion may be pressed against the base material 10, and the trim cords 40 may be fixed to the engaging portions 6B of the lower terminal portions 12a and 12b. Since attaching is performed in such a manner, the attaching can be performed while suppressing the undulation and distortion of the stitch 15.

### Point-shaped Locking Member

The armrest 1 is provided with point-shaped locking portions 4 that lock the skin material 20, in addition to the engaging portions 6 that engage with the linear locking members 5 that are the suspender cords 30 and the trim cords 40. As shown in FIG. 2, the point-shaped locking portions 4 are provided between the engaging portions 6 that lock the linear locking members 5, and lock portions of the skin material 20, which cannot be secured by the linear locking members 5. For example, at the front end 1c of the armrest 1, the skin material 20 is attached using hemming, and the point-shaped locking portions 4 are used to fix the hemming. In addition, the skin material 20 may be secured by hooking terminal portions of the skin material 20.

### Another Example 1 of Linear Locking Member

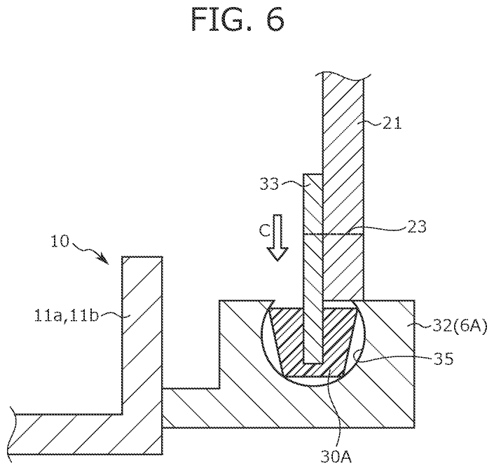

Next, another example of the linear locking members 5 provided at the upper terminal portions 11a and 11b of the base material 10 will be described with reference to FIG. 6. Suspender cords 30A shown in FIG. 6 are the linear locking members 5, are formed with a trapezoidal cross-sectional shape, and are connected to the upper end portion 21 of the skin material 20 via the nonwoven fabric 33. The nonwoven fabric 33 and the upper end portion 21 of the skin material 20 are joined by a sewing portion 23.

As shown in FIG. 6, at the upper terminal portions 11a and 11b of the base material 10, holding portions 32 in which recesses 35 including openings on the upper side are formed are provided as the engaging portions 6A. By inserting the suspender cords 30A downward (in the direction of arrow C) into the recesses 35, the holding portions 32 and the suspender cords 30A can engage with each other, and the upper end portion 21 of the skin material 20 can be attached to the base material 10.

### Another Example 2 of Linear Locking Member

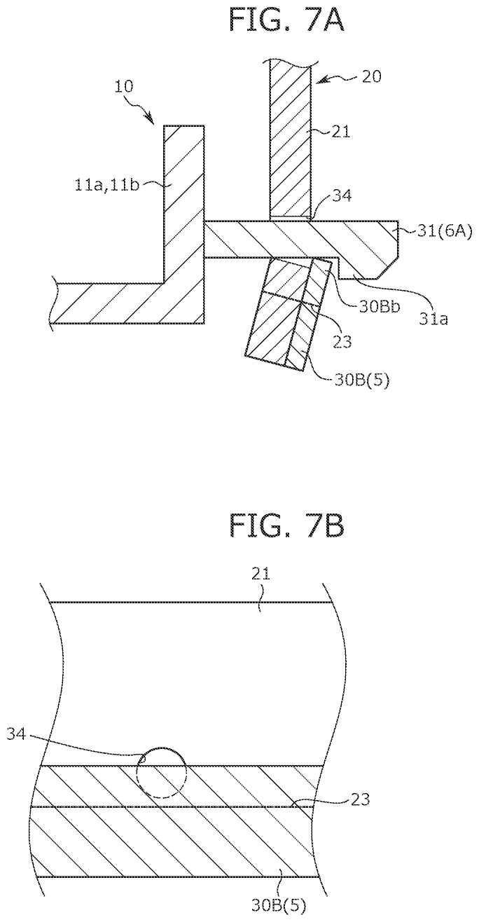

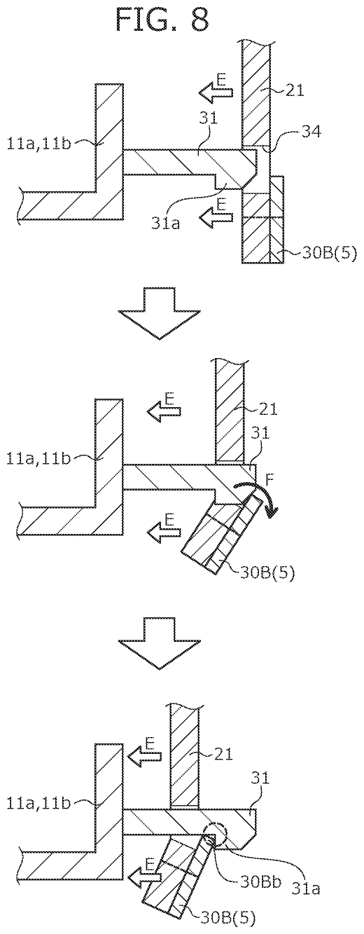

Next, another example of the linear locking members 5 provided at the upper terminal portions 11a and 11b will be described with reference to FIG. 7A to 8. Trim cords 30B having an elongated flat plate shape are attached to the upper end portion 21 of the skin material 20, as the linear locking members 5.

The hook portions 31 are provided as the engaging portions 6A so as to extend from the upper terminal portions 11a and 11b of the base material 10 toward the outside. On the other hand, as shown in FIG. 7B, the through-holes 34 through which the hook portions 31 pass are formed in the vicinity of the upper end portion 21 of the skin material 20. As shown in FIG. 7B, portions of the through-holes 34 are disposed at positions overlapping the trim cords 30B. Since there are the overlapping portions, as shown in FIG. 7A, after the trim cords 30B are attached, upper side portions 30Bb of the trim cords 30B move rotationally and come into contact with the return portions 31a, so that the trim cords 30B are slightly inclined.

In describing the attachment procedure with reference to FIG. 8, as shown at the upper part of FIG. 8, the tip of the hook portion 31 is inserted into the through-hole 34 of the skin material 20. When the upper end portion 21 is moved in the direction of arrow E toward the inside, as shown at the middle part of FIG. 8, the tip of the hook portion 31 comes into contact with the upper side portion 30Bb of the trim cord 30B, and the trim cord 30B moves rotationally in the direction of arrow F. The trim cord 30B rotates, but since the trim cord 30B stretches, workability is not affected.

As shown at the lower part of FIG. 8, when the trim cord 30B is moved in the direction of arrow E, the hook portion 31 passes over the trim cord 30B, and the upper side portion 30Bb of the trim cord 30B comes into contact with the return portion 31a. Accordingly, the trim cord 30B is attached to the upper terminal portion 11b of the base material 10 so as to be difficult to come off from the hook portion 31.

### Another Example 3 of Linear Locking Member

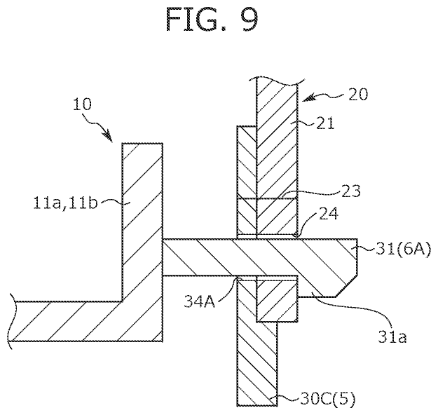

The trim cords 30B (linear locking members 5) shown in FIG. 8 are disposed outside the upper end portion 21 of the skin material 20; however, as shown in FIG. 9, trim cords 30C may be disposed inside the upper end portion 21. In this case, the trim cords 30C and the upper end portion 21 are joined by the sewing portion 23, and through-holes 34A penetrating through both the trim cords 30C and the upper end portion 21 are provided. During attachment, the trim cords 30C are attached by causing the hook portions 31 to pass through the through-holes 34A, the hook portions 31 extending from the upper terminal portions 11a and 11b of the base material 10. Since the hook portions 31 pass through the through-holes 34A penetrating through both the trim cords 30C and the skin material 20, the upper end portion 21 of the skin material 20 can be more firmly attached.

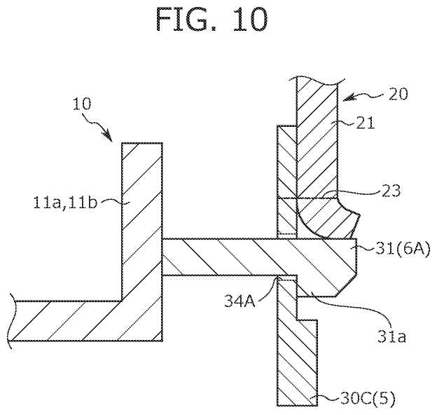

Incidentally, as shown in FIG. 10, the through-holes 34 may be formed only in the trim cords 30C. Accordingly, the yield is improved compared to when the through-holes 34 are formed on both the trim cords 30C and the skin material 20.

### Method for Manufacturing Interior Member

A method for manufacturing the armrest 1 that is an interior member of the vehicle door D which is the present embodiment will be described below.

The base material 10 of the armrest 1 having the design surface 2 and the skin material 20 covering the base material 10 are prepared (step S01). At this time, the linear locking members 5 (the suspender cords 30 or the trim cords 40) are provided at the end portions (the upper end portion 21 and the lower end portion 22) of the skin material 20.

Next, the linear locking members 5 are attached at positions that are not visible from the design surface side of the base material 10 (step S02). More specifically, the linear locking members 5 are engaged with the engaging portions 6 provided on the back surface 10b of the base material 10. Accordingly, the armrest 1 covered with the skin material 20 is completed.

When the base material 10 is covered with the skin material 20, the linear locking members 5 located at one end portion may be engaged with the engaging portions 6, and then the stitch 15 as a design line located at the intermediate portion may be pressed against the base material 10, and the linear locking members 5 located at the other end portion may be fixed to the engaging portions 6. By performing fixation in such a manner, slack wrinkles are suppressed and the undulation or distortion of the stitch 15 is suppressed, so that the appearance merchantability can be improved.

As the interior component for a conveyance of the present embodiment, the armrest provided on the door lining for a vehicle has been described above with reference to the drawings. However, the interior component for a conveyance is not limited to the armrest, and the present invention can be applied to various interior components. For example, the present invention can be also applied to an upper member, a center member, a lower member, a pillar, a front instrument panel, a seat back, and the like to which a skin material is attached.

### Second Embodiment

Next, a second embodiment of the present invention will be described. The second embodiment relates to a conveyance seat, particularly to a conveyance seat including a skin that engages with a frame.

In the related art, a vehicle seat installed in a conveyance such as an automobile includes a skin that covers a pad disposed on a frame and that is fixed to the frame. The skin is fixed by sewing a plurality of hook pieces to an end portion of the skin and by hooking the plurality of hook pieces onto the frame or the like (for example, refer to JP H11-206522 A).

However, the work of a worker hooking the plurality of hook pieces onto predetermined positions on the frame one by one takes significant effort and time. For this reason, when the conveyance seat is manufactured, means for more easily attaching the skin to the frame has been desired (first problem).

In addition, when the skin covering the pad is fixed to the frame using the method of the related art, the skin is strongly fixed to the frame, so that for example, when an occupant is seated, the skin follows the buttocks of the occupant and a peeling force is applied to a connection portion between the skin and the frame. When the occupant moves significantly, there is a possibility that the connection portion is damaged, so in order to reduce the force applied to the connection portion, means for attaching the skin that is displaced to follow the movement of the occupant to some extent has been desired (second problem).

In addition, after the hook pieces are hooked onto the frame or the like, the hook pieces or hooking portions of the frame may not be visually recognized from the outside (third problem).

### Technical Problem

The second embodiment has been made in view of the first problem, and an object of the second embodiment is to provide a conveyance seat in which a skin covering a pad is more easily attached to a frame.

In addition, the second embodiment has been made in view of the second problem, and an object of the second embodiment is to provide a conveyance seat including a skin that is attached so as to be displaceable to follow the movement of a seated occupant.

In addition, the second embodiment has been made in view of the third problem, and an object of the second embodiment is to provide a conveyance seat and a method for manufacturing a conveyance seat in which even after a skin is attached to a pad, engaging members such as hook pieces are not exposed.

### Solution to Problem

The first problem is solved by a conveyance seat of the second embodiment including: a frame; a pad disposed on the frame; and a skin covering the pad. The skin includes a frame engaging member that engages with the frame, at an end portion of the skin. A plurality of engaging portions are formed in the frame engaging member. A plurality of engaged portions corresponding to the plurality of engaging portions are provided on the frame.

According to the conveyance seat of the second embodiment configured as described above, since the plurality of engaging portions are formed in the frame engaging member that engages with the frame, the frame engaging member can be collectively attached to the engaged portions formed on the frame. For this reason, the skin can be more easily attached to the frame without attaching hook members one by one as in the related art, so that workability when assembling the conveyance seat is improved.

In the conveyance seat, each of the plurality of engaged portions may be formed of an L-shaped hook integrally formed with the frame.

Since an L-shaped hook is used as the engaged portion, each of the engaging portions of the frame engaging member easily engages with the engaged portion. For this reason, the skin can be more easily attached to the frame.

In the conveyance seat, the frame engaging member may be a plate-shaped plate member attached along the end portion of the skin.

Since the frame engaging member is a plate-shaped plate member, the plurality of engaging portions can be collectively attached to the engaged portions of the frame, so that the skin can be more easily attached to the frame.

In the conveyance seat, the plurality of engaging portions may include respective opening portions into which the engaged portions are inserted, and the opening portions may be formed side by side along the end portion of the skin in the vicinity of an end portion of the plate member.

Since the opening portions into which the engaged portions are inserted are formed, the engaged portions are easily hooked, so that the skin can be more easily attached to the frame.

In addition, in the conveyance seat, the opening portions may be formed in a trapezoidal shape.

Since the opening portions are formed in a trapezoidal shape, the coming off of the engaged portions from the opening portions becomes difficult.

In the conveyance seat, the opening portions may be formed by slits having an H shape or a U shape.

Since the opening portions are formed by slits having an H shape or a U shape, the intrusion of dust or debris from the opening portions can be suppressed.

In the conveyance seat, the opening portions may be formed by cutouts formed in the plate member and the end portion of the skin, which closes openings of the cutouts.

Since the opening portions are formed by forming the cutouts in the plate member and by closing the openings of the cutouts with the end portion of the skin, the opening portions can be easily formed.

In the conveyance seat, throttle portions protruding toward insides of the opening portions may be provided at side portions of the opening portions.

Since the throttle portions protruding to the insides are provided at the side portions of the opening portions, the coming off of the engaged portions inserted into the opening portions becomes difficult.

In the conveyance seat, a length of engagement sides of the opening portions, which engage with the engaged portions, may be formed to be larger than a length of portions where the engaged portions engage with the engaging portions.

Since the length of the engagement sides of the opening portions is set to be larger than the length of the portions where the engaged portions engage with the engaging portions, a margin for the width of the shift of the skin covering the pad can be created, and even when an occupant shifts his or her body while seated in the seat, the skin easily follows the shift of the body. For this reason, damage to the skin or the like is suppressed.

In the conveyance seat, the frame engaging member may be a wire member attached along the end portion of the skin, and portions of the wire member exposed by cutouts formed at the end portion of the skin may engage with the engaged portions provided on the frame.

Since a wire member is used as the frame engaging member, the frame engaging member can be easily formed.

The second problem is solved by a conveyance seat of the second embodiment including: a frame; a pad disposed on the frame; and a skin covering the pad. The skin includes a frame engaging member that engages with the frame, at an end portion of the skin. An engaging portion is formed in the frame engaging member. An engaged portion corresponding to the engaging portion is provided on the frame. The frame engaging member is a plate-shaped plate member attached along the end portion of the skin. The engaging portion includes an opening portion into which the engaged portion is inserted. A length of an engagement side of the opening portion, which engages with the engaged portion, is formed to be larger than a length of a portion where the engaged portion engages with the engaging portion.

As described above, since the length of the engagement side of the opening portion is set to be larger than the length of the portion where the engaged portion engages with the engaging portion, namely, a play portion is formed in the opening portion, the skin covering the pad can be displaced. Even when the occupant shifts his or her body while seated in the seat, the skin easily follows the shift of the body, so that damage to the skin or the like is suppressed.

In the conveyance seat, the engaged portion may be formed of an L-shaped hook integrally formed with the frame.

Since an L-shaped hook is used as the engaged portion, each of the engaging portions of the frame engaging member easily engages with the engaged portion, so that the skin can be easily attached to the frame.

In the conveyance seat, a plurality of the engaging portions may be formed in the frame engaging member, and a plurality of the engaged portions may be provided to correspond to the plurality of engaging portions.

Since the plurality of engaging portions are formed in the frame engaging member that engages with the frame, the frame engaging member can be collectively attached to the engaged portions formed on the frame. In the related art, the hook members are attached one by one; however, since the frame engaging member is collectively attached, the skin can be more easily attached to the frame, so that workability when assembling the conveyance seat is improved.

In the conveyance seat, the length of the engagement side of the opening portion, which engages with the engaged portion, may be 1.2 to 2.0 times the length of the portion where the engaged portion engages with the engaging portion.

Since a play is provided by setting the size of the engagement side to be 1.2 to 2.0 times that of the engaged portion, the skin covering the pad is more significantly displaced, so that damage to the skin or the like is suppressed.

In the conveyance seat, the opening portion may be formed in a trapezoidal shape.

Since the opening portion is formed in a trapezoidal shape, the coming off of the engaged portion from the opening portion becomes difficult.

In the conveyance seat, the opening portion may be formed by a slit having an H shape or a U shape.

Since the opening portion is formed by a slit having an H shape or a U shape, the intrusion of dust or debris from the opening portion can be suppressed.

In the conveyance seat, the opening portion may be formed by a cutout formed in the frame engaging member and the end portion of the skin, which closes an opening of the cutout.

Since the opening portion is formed by forming the cutout in the plate member and by closing the opening of the cutout with the end portion of the skin, the opening portion can be easily formed.

In the conveyance seat, a throttle portion protruding toward an inside of the opening portion may be provided at a side portion of the opening portion.

Since the throttle portion protruding to the inside is provided at the side portion of the opening portion, the coming off of the engaged portion inserted into the opening portion becomes difficult.

In the conveyance seat, the opening portion may be an elongated hole extending along the end portion of the skin.

Since the opening portion is an elongated hole, the coming off of the engaged portion inserted into the opening portion becomes difficult.

In the conveyance seat, the engaged portion may be inserted into the opening portion from a surface side of the frame engaging member, and in a state where the engaging portion and the engaged portion are engaged with each other, the skin may be folded at a connection portion with the frame engaging member, and may be disposed such that the engaged portion is covered with the skin.

Since the engaged portion is covered with the skin, the engaged portion is not exposed and is not visually recognized from the outside, so that design appeal is improved.

The third problem is solved by a conveyance seat of the second embodiment including: a frame; a pad disposed on the frame; and a skin covering the pad. The skin includes a frame engaging member that engages with the frame, at an end portion of the skin. An engaging portion is formed in the frame engaging member. An engaged portion corresponding to the engaging portion is provided on the frame. The engaged portion is engaged from a surface side of the frame engaging member. In a state where the engaging portion and the engaged portion are engaged with each other, the skin is folded at a connection portion with the frame engaging member, and is disposed such that the engaged portion is covered with the skin.

In addition, the third problem is solved by a method for manufacturing a conveyance seat according to the second embodiment, the method including: a step of preparing a frame, a pad, and a skin covering the pad; a step of disposing the pad on the frame and covering the pad with the skin; a step of engaging an engaged portion that is provided on the frame to correspond to an engaging portion of a frame engaging member that is provided at an end portion of the skin to engage with the frame, with the engaging portion from a surface side of the skin; and a step of folding the end portion of the skin at a connection portion with the frame engaging member and covering the engaged portion with the skin.

In the conveyance seat and the method for manufacturing a conveyance seat according to the second embodiment configured as described above, since the engaged portion is covered with the skin in a state where the engaging portion of the frame engaging member and the engaged portion of the frame are engaged with each other, the engaged portion (for example, a hook or the like) is not exposed. For this reason, the engaged portion is not visually recognized from the outside, so that the design appeal of the conveyance seat is improved.

In the conveyance seat, the engaged portion may be formed of an L-shaped hook integrally formed with the frame.

Since an L-shaped hook is used as the engaged portion, each engaging portion of the frame engaging member easily engages with the engaged portion. For this reason, the skin can be more easily attached to the frame.

In the conveyance seat, the frame engaging member may be a plate-shaped plate member attached along the end portion of the skin, and the engaging portion may include an opening portion into which the engaged portion is inserted.

Since the frame engaging member is a plate member, the opening portion having a higher strength compared to when the opening portion is formed in the skin can be formed.

In the conveyance seat, a length of an engagement side of the opening portion, which engages with the engaged portion, may be formed to be larger than a length of a portion where the engaged portion engages with the engaging portion.

Since the length of the engagement side of the opening portion is set to be larger than the length of the portion where the engaged portion engages with the engaging portion, namely, a play portion is formed in the opening portion, the skin covering the pad can be displaced. Even when an occupant shifts his or her body while seated in the seat, the skin easily follows the shift of the body, so that damage to the skin or the like is suppressed.

In the conveyance seat, the opening portion may be formed in a trapezoidal shape.

Since the opening portion is formed in a trapezoidal shape, the coming off of the engaged portion from the opening portion becomes difficult.

In the conveyance seat, the opening portion may be formed by a slit having an H shape or a U shape.

Since the opening portion is formed by a slit having an H shape or a U shape, the intrusion of dust or debris from the opening portion can be suppressed.

In the conveyance seat, the opening portion may be formed by a cutout formed in the frame engaging member and the end portion of the skin, which closes an opening of the cutout.

Since the opening portion is formed by forming the cutout in the plate member and by closing the opening of the cutout with the end portion of the skin, the opening portion can be easily formed.

In the conveyance seat, a throttle portion protruding toward an inside of the opening portion may be provided at a side portion of the opening portion.

Since the throttle portion protruding to the inside is provided at the side portion of the opening portion, the coming off of the engaged portion inserted into the opening portion becomes difficult.

In the conveyance seat, the opening portion may be an elongated hole extending along the end portion of the skin.

Since the opening portion is an elongated hole, the coming off of the engaged portion inserted into the opening portion becomes difficult.

### Advantageous Effects of Invention

According to the conveyance seat of the second embodiment, since the plurality of engaging portions are formed in the frame engaging member that engages with the frame, the frame engaging member can be collectively attached to the engaged portions formed on the frame. For this reason, the skin can be more easily attached to the frame without attaching the hook members one by one as in the related art, so that workability when assembling the conveyance seat is improved.

In addition, since L-shaped hooks are used as the engaged portions, each of the engaging portions of the frame engaging member easily engages with the engaged portions. For this reason, the skin can be more easily attached to the frame.

In addition, since the frame engaging member is a plate-shaped plate member, the plurality of engaging portions can be collectively attached to the engaged portions of the frame, so that the skin can be more easily attached to the frame.

In addition, since the opening portions into which the engaged portions are inserted are formed, the engaged portions are easily hooked, so that the skin can be more easily attached to the frame.

In addition, since the opening portions are formed in a trapezoidal shape, the coming off of the engaged portions from the opening portions becomes difficult.

In addition, since the opening portions are formed by slits having an H shape or a U shape, the intrusion of dust or debris from the opening portions can be suppressed.

Since the opening portions are formed by forming the cutouts in the plate member and by closing the openings of the cutouts with the end portion of the skin, the opening portions can be easily formed.

Since the throttle portions protruding to the insides are provided at the side portions of the opening portions, the coming off of the engaged portions inserted into the opening portions becomes difficult.

In addition, since the length of the engagement sides of the opening portions is set to be larger than the length of the portions where the engaged portions engage with the engaging portions, a margin for the width of the shift of the skin covering the pad can be created, and even when the occupant shifts his or her body while seated in the seat, the skin easily follows the shift of the body. For this reason, damage to the skin or the like is suppressed.

In addition, since a wire member is used as the frame engaging member, the frame engaging member can be easily formed.

In addition, according to the conveyance seat of the second embodiment, since the length of the engagement side of the opening portion is set to be larger than the length of the portion where the engaged portion engages with the engaging portion, namely, a play portion is formed in the opening portion, the skin covering the pad can be displaced. Even when the occupant shifts his or her body while seated in the seat, the skin easily follows the shift of the body, so that damage to the skin or the like is suppressed.

In addition, since an L-shaped hook is used as the engaged portion, each engaging portion of the frame engaging member easily engages with the engaged portion, so that the skin can be easily attached to the frame.

In addition, since the plurality of engaging portions are formed in the frame engaging member that engages with the frame, the frame engaging member can be collectively attached to the engaged portions formed on the frame. In the related art, the hook members are attached one by one; however, since the frame engaging member is collectively attached, the skin can be more easily attached to the frame, so that workability when assembling the conveyance seat is improved.

In addition, since the size of the engagement side is set to be 1.2 to 2.0 times that of the engaged portion, the skin covering the pad is more significantly displaced, so that damage to the skin or the like is suppressed.

In addition, since the opening portion is formed in a trapezoidal shape, the coming off of the engaged portion from the opening portion becomes difficult.

In addition, since the opening portion is formed by a slit having an H shape or a U shape, the intrusion of dust or debris from the opening portion can be suppressed.

In addition, since the opening portion is formed by forming the cutout in the plate member and by closing the opening of the cutout with the end portion of the skin, the opening portion can be easily formed.

In addition, since the throttle portion protruding to the inside is provided at the side portion of the opening portion, the coming off of the engaged portion inserted into the opening portion becomes difficult.

In addition, since the opening portion is formed by an elongated hole, the coming off of the engaged portion inserted into the opening portion becomes difficult.

In addition, since the engaged portion is covered with the skin, the engaged portion is not exposed and is not visually recognized from the outside, so that design appeal is improved.

In addition, in the conveyance seat and the method for manufacturing a conveyance seat according to the second embodiment, since the engaged portion is covered with the skin in a state where the engaging portion of the frame engaging member and the engaged portion of the frame are engaged with each other, the engaged portion (for example, a hook or the like) is not exposed. For this reason, the engaged portion is not visually recognized from the outside, so that the design appeal of the conveyance seat is improved.

In addition, since an L-shaped hook is used as the engaged portion, each engaging portion of the frame engaging member easily engages with the engaged portion. For this reason, the skin can be more easily attached to the frame.

In addition, since the frame engaging member is a plate member, the opening portion having a higher strength compared to when the opening portion is formed in the skin can be formed.

In addition, since the length of the engagement side of the opening portion is set to be larger than the length of the portion where the engaged portion engages with the engaging portion, namely, a play portion is formed in the opening portion, the skin covering the pad can be displaced. Even when the occupant shifts his or her body while seated in the seat, the skin easily follows the shift of the body, so that damage to the skin or the like is suppressed.

In addition, since the opening portion is formed in a trapezoidal shape, the coming off of the engaged portion from the opening portion becomes difficult.

In addition, since the opening portion is formed by a slit having an H shape or a U shape, the intrusion of dust or debris from the opening portion can be suppressed.

In addition, since the opening portion is formed by forming the cutout in the plate member and by closing the opening of the cutout with the end portion of the skin, the opening portion can be easily formed.

In addition, since the throttle portion protruding to the inside is provided at the side portion of the opening portion, the coming off of the engaged portion inserted into the opening portion becomes difficult.

In addition, since the opening portion is an elongated hole, the coming off of the engaged portion inserted into the opening portion becomes difficult.

### Description of Embodiment

Hereinafter, a configuration of a conveyance seat according to the second embodiment of the present invention (present embodiment) will be described with reference to the drawings. However, the embodiment to be described below is one example for facilitating understanding of the present invention, and does not limit the present invention. Namely, the present invention can be modified and improved without departing from the concept of the present invention, and it goes without saying that the present invention includes equivalents of the present invention.

Incidentally, hereinafter, a vehicle seat will be provided as one example of the conveyance seat, and a configuration example of the vehicle seat will be described. However, the present invention is not limited to the vehicle seat mounted in ground traveling conveyances including wheels such as an automobile and a railway, and may be a seat mounted in an aircraft, a ship, or the like moving in environments other than the ground.

In addition, in the following description, a “front to rear direction” is the front to rear direction of the vehicle seat, and is a direction coinciding with the forward movement direction of a vehicle when traveling. In addition, a “seat width direction” is the width direction of the vehicle seat, and is a direction coinciding with a right to left direction when viewed from an occupant seated in the vehicle seat. In addition, an “up to down direction” is the up to down direction of the vehicle seat, and is a direction coinciding with a vertical direction when the vehicle travels on a horizontal surface.

In addition, in the following description, when various directions are described with the term “seat” added thereto, such as the “seat width direction” and a “seat height direction”, the various directions indicate directions with respect to the vehicle seat, and when directions are described with the term “vehicle” added thereto, such as a “vehicle inside” and a “vehicle outside”, the directions indicate directions with respect to the vehicle.

In addition, in the following description, unless otherwise specified, the shape, position, posture, and the like of each portion of the vehicle seat will be described based on the assumption that the vehicle seat is in a seated state to be described later.

### Basic Configuration of Vehicle Seat

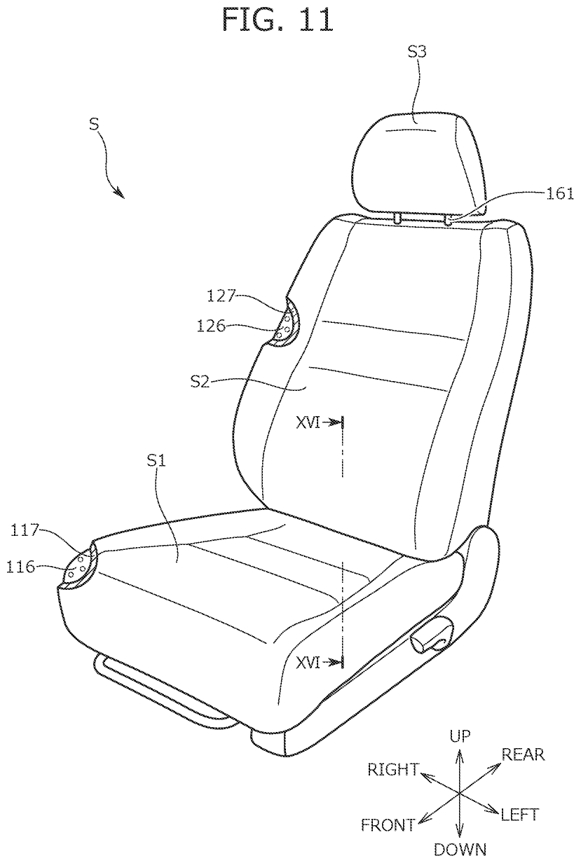

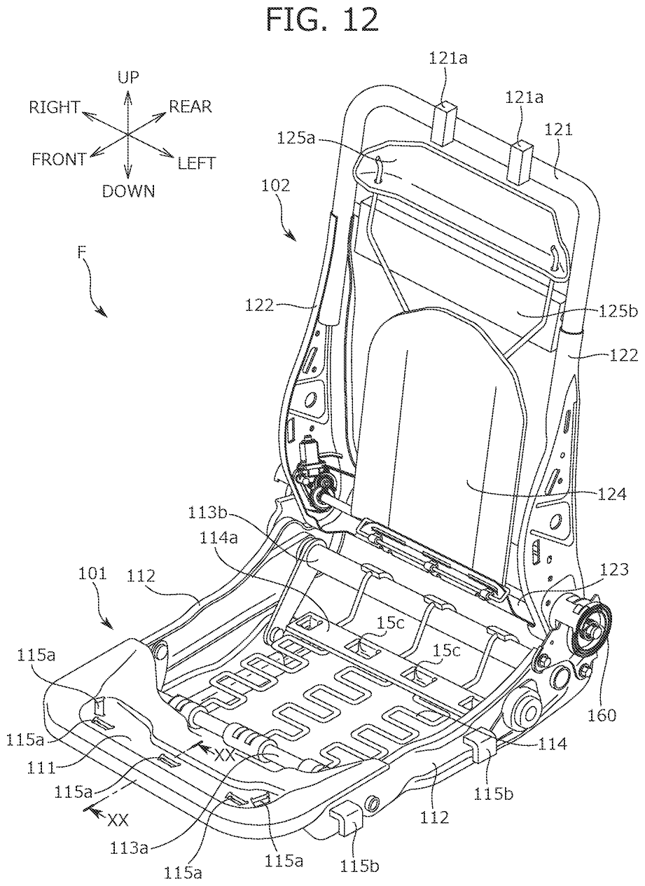

A basic configuration of the vehicle seat according to the present embodiment (hereinafter, a vehicle seat S) will be described with reference to FIGS. 11 and 12. FIG. 11 is a perspective view of the vehicle seat S. In FIG. 11, for convenience of illustration, a portion of the vehicle seat S is illustrated with trim covers 117 and 127, which are skins, removed.

The vehicle seat S is a seat which is placed on a vehicle body floor and in which the occupant of the vehicle is seated. In the present embodiment, the vehicle seat S is used as a front seat corresponding to a front seat of the vehicle. However, the vehicle seat S is not limited to the front seat, and the vehicle seat S may be a rear seat of the vehicle, and can also be used as a middle seat in a second row or a rear seat in a third row of a vehicle including three rows of seats in the front to rear direction.

As shown in FIG. 11, the vehicle seat S includes, as main components, a seat cushion S1 serving as a seating portion that supports the buttocks of the seated occupant, a seat back S2 serving as a backrest portion that supports the back of the seated occupant, and a headrest S3 that is disposed on an upper portion of the seat back S2 to support the head of the seated occupant. The seat cushion S1 and the seat back S2 are connected to each other with a reclining mechanism 160 (refer to FIG. 12) interposed therebetween. In addition, although not illustrated, a slide rail is installed below the seat cushion S1, and the vehicle seat S is placed on the vehicle body floor in a state where the vehicle seat S is slidingly movable in the front to rear direction by the slide rail.

A frame F shown in FIG. 12 is provided inside the vehicle seat S, and the frame F mainly includes a cushion frame 101 and a back frame 102. The cushion frame 101 forms a skeleton of the seat cushion S1 in the frame F, and the back frame 102 forms a skeleton of the seat back S2 in the frame F.

A rear end portion of the seat cushion S1 is connected to a lower end portion of the seat back S2. In addition, the seat cushion S1 is formed by placing a cushion pad 116 on the cushion frame 101 and by covering the cushion pad 116 with the cushion trim cover 117. The seat back S2 is formed by placing a back pad 126 on the back frame 102 and by covering the back pad 126 with the back trim cover 127.

The cushion pad 116 and the back pad 126 are, for example, urethane base materials molded by foam molding using a urethane foaming agent. The cushion pad 116 and the back pad 126 correspond to pads of the second embodiment. In addition, the cushion trim cover 117 and the back trim cover 127 correspond to skins of the second embodiment, and are made of a fabric, film, cloth, leather, sheet, or the like. In addition, the trim covers 117 and 127 are attached to cover the cushion pad 116 and the back pad 126 in a state where the trim covers 117 and 127 are stretched such that a predetermined tension is applied thereto.

In the present embodiment, when the cushion pad 116 is covered with the cushion trim cover 117, end portions of the trim cover 117 are attached to predetermined locations, and the attachment method will be described later.

As shown in FIG. 12, the cushion frame 101 of the frame F has a substantially square frame-shaped outer shape. Further, the cushion frame 101 includes, as main components, a pair of cushion side frames 112 constituting respective right and left end portions in the seat width direction, a pan frame 111 constituting a front end portion of the cushion frame 101, and springs 114 (S springs).

In order to define a width of the cushion frame 101, two cushion side frames 112 are disposed to be separated from each other in the right to left direction and to extend in the front to rear direction of the vehicle. Further, a front pipe 113a and a rear pipe 113b that connect the two cushion side frames 112 are attached to front end portions and rear end portions of the two cushion side frames 112, respectively.

The pan frame 111 is fixedly joined to a front side of the pair of cushion side frames 112, and the right and left cushion side frames 112 are connected on the front side by the pan frame 111. In more detail, end portions of the pan frame 111 in the right to left direction are fixed to respective flanges provided on the cushion side frames 112, by fixing means such as welding.

The pan frame 111 is mainly for supporting the thighs of the seated occupant (occupant), and is a frame made of a metal plate material formed in a substantially rectangular shape with a substantially flat upper surface.

A plurality of the springs 114 (S springs 114) as pressure receiving portions are provided side by side in the seat width direction between the right and left cushion side frames 112. The springs 114 extend long in the seat front to rear direction. Front end portions of the springs 114 are fixed to the front pipe 113a, and rear end portions of the springs 114 are secured to the rear pipe 113b. In addition, a pressure receiving plate 114a is provided on the springs 114.

### Engaged Portion

A plurality of hooks 115a (engaged portions) for attaching the end portion of the trim cover 117 are formed on a lower surface of the pan frame 111. The cross section of the hooks 115a is formed in an L shape, and the hooks 115a are provided by cutting and raising portions of the pan frame 111.

A plurality of hooks 115b (engaged portions) for attaching the end portions of the trim cover 117 are formed on each of the right and left cushion side frames 112. The cross section of the hooks 115b is formed in an inverted L shape as shown in FIG. 12, and the hooks 115b are provided by cutting and raising portions of the cushion side frames 112.

Similarly to the cushion side frames 112 and the pan frame 111, a plurality of hooks 115c (engaged portions) for attaching the end portion of the trim cover 117 are formed on a lower surface of the pressure receiving plate 114a. The cross section of the hooks 115c is formed in an L shape, and the hooks 115c are provided by cutting and raising portions of the pressure receiving plate 114a. Incidentally, in the following description, unless otherwise specifically distinguished, the hooks 115a to 115c provided on the cushion side frames 112, the pan frame 111, and the pressure receiving plate 114a may be simply referred to as hooks 115.

### Back Frame

The back frame 102 is mainly made of a pipe processed in a square frame shape, and as shown in FIG. 12, the back frame 102 includes an upper frame 121 having an inverted U shape; a pair of back side frames 122 forming right and left end portions in the seat width direction; and a lower frame 123 connecting lower end portions of the pair of back side frames 122.

In addition, on the back frame 102, a pressure receiving plate 124 suspended on the back frame 102 is provided, and a suspension frame 125 for suspending the pressure receiving plate 124 is provided to span the right and left back side frames 122. Headrest guides 121a having a tubular shape are attached to an upper end central portion of the back frame 102. The headrest S3 is attached to the seat back S2 by inserting headrest pillars 161, which extend from a lower end of the headrest S3, into the headrest guides 121a.

Examples of a constituent material of each member constituting the cushion frame 101 and the back frame 102 include a material having sufficient rigidity so as not to be significantly deformed when subjected to a load, for example, a metal material such as a steel or aluminum alloy. Joining means for the members constituting the cushion frame 101 and the back frame 102 is welding; however, as the joining means, joining using bolts or an adhesive agent may be used in combination.

### Cushion Trim Cover

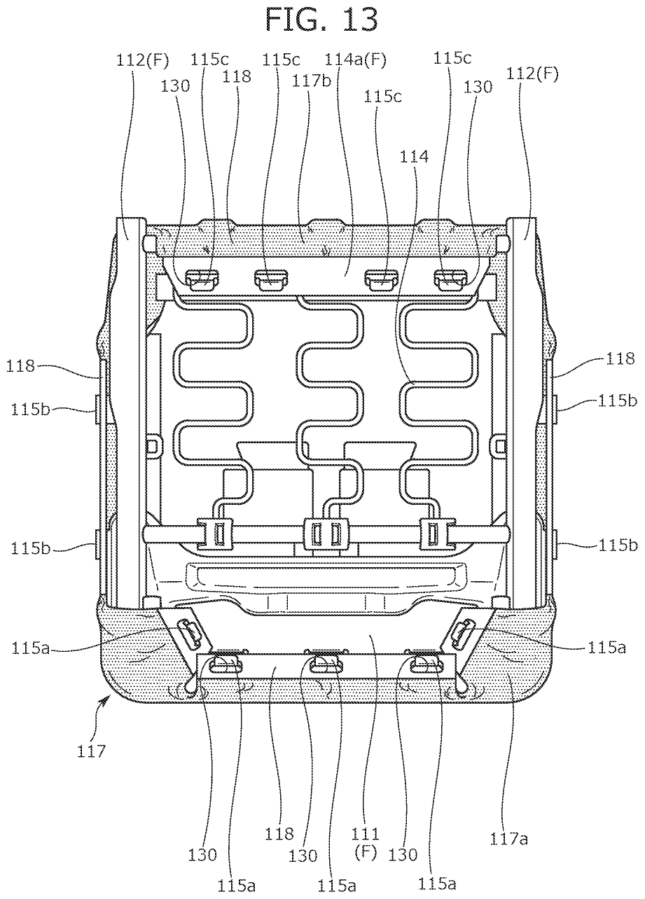

Next, a configuration of the cushion trim cover 117 will be described with reference to FIGS. 13 to 16. The trim cover 117 is a member covering the cushion pad 116 of the seat cushion S1, and includes a cover body 117a and an extension portion 117b.

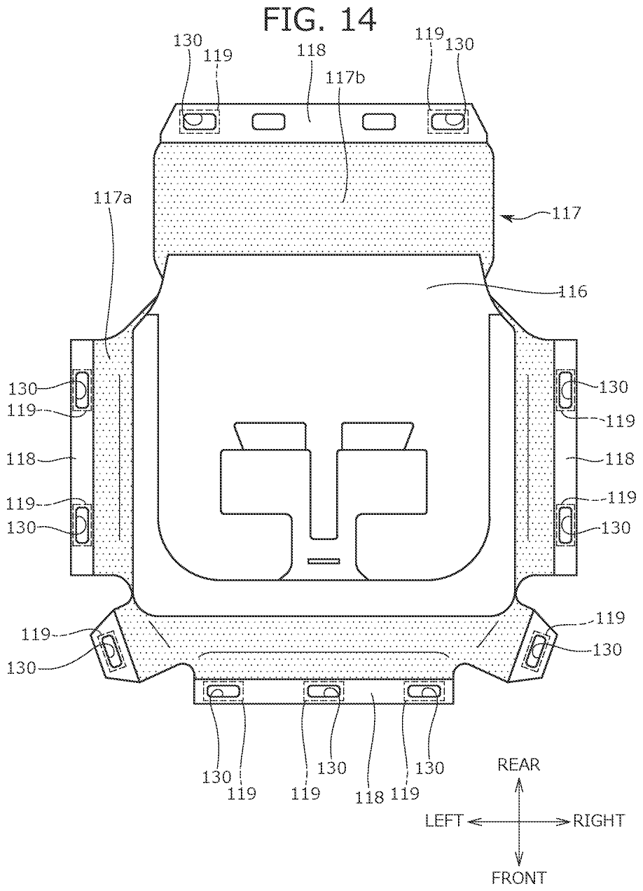

The cover body 117a covers an upper surface, a front surface, and both side surfaces of the cushion pad 116. The extension portion 117b is a portion extending from a rear end portion of the cover body 117a as shown in FIG. 14, and covers the surface of a protruding portion 116a protruding rearward from the cushion pad 116 as shown in FIG. 16. Incidentally, the protruding portion 116a of the cushion pad 116 is inserted into a gap V between the seat back S2 and the rear pipe 113b of the cushion frame 101.

### Frame Engaging Member

Frame engaging members 118 that engage with the hooks 115 (engaged portions) provided on the cushion frame 101 are provided at the end portions of the trim cover 117.

In addition, a plurality of engaging portions 119 are formed in the frame engaging members 118. A plurality of the hooks 115 that are the engaged portions of the present invention are provided on the cushion frame 101 so as to correspond to positions where the engaging portions 119 are disposed. The plurality of engaging portions 119 may be formed in the frame engaging members 118 so as to correspond to positions where the hooks 115 are provided on the cushion frame 101.

As shown in FIGS. 13 and 14, the frame engaging members 118 are plate-shaped plate members attached along end portions of the cover body 117a of the trim cover 117. The frame engaging members 118 are attached to the end portions of the cover body 117a by sewing. The frame engaging member 118 is also attached to a tip of the extension portion 117b of the trim cover 117 by sewing.

The frame engaging members 118 having a plate shape are made of hard synthetic resin, for example, polypropylene resin or vinyl chloride resin. The frame engaging members 118 may be made of metal such as iron or aluminum. In addition, the thickness of the frame engaging members 118 is preferably 1 to 8 mm, more preferably 1.5 to 5 mm.

The frame engaging members 118 are attached to the cover body 117a of the trim cover 117 by sewing, but may be joined using an adhesive agent.

In addition, each of the frame engaging members 118 may be formed thicker at a tip portion, which engages with the hook 115, than at other portions. By making the tip portion thicker, the strength is increased and damage is suppressed.

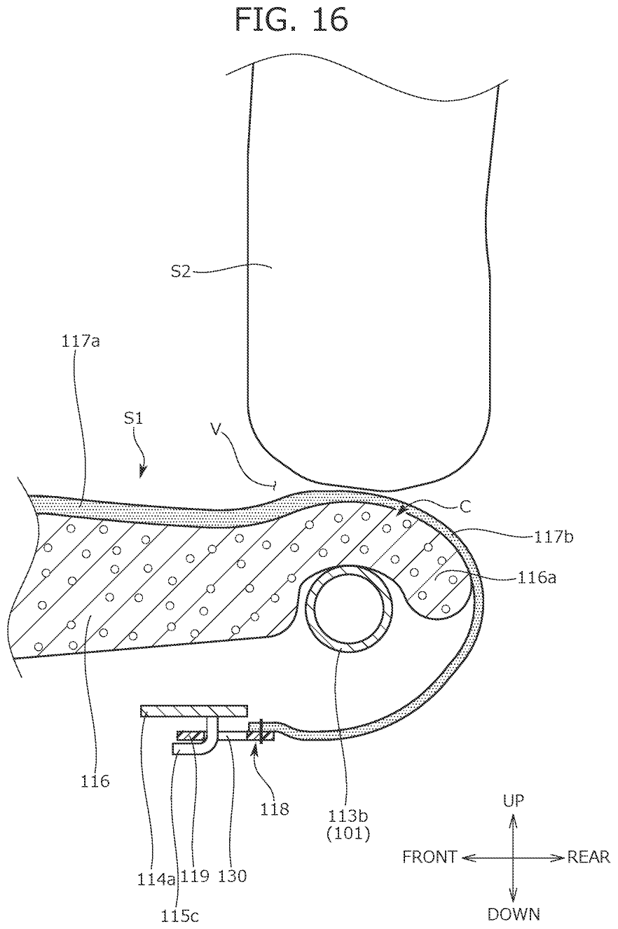

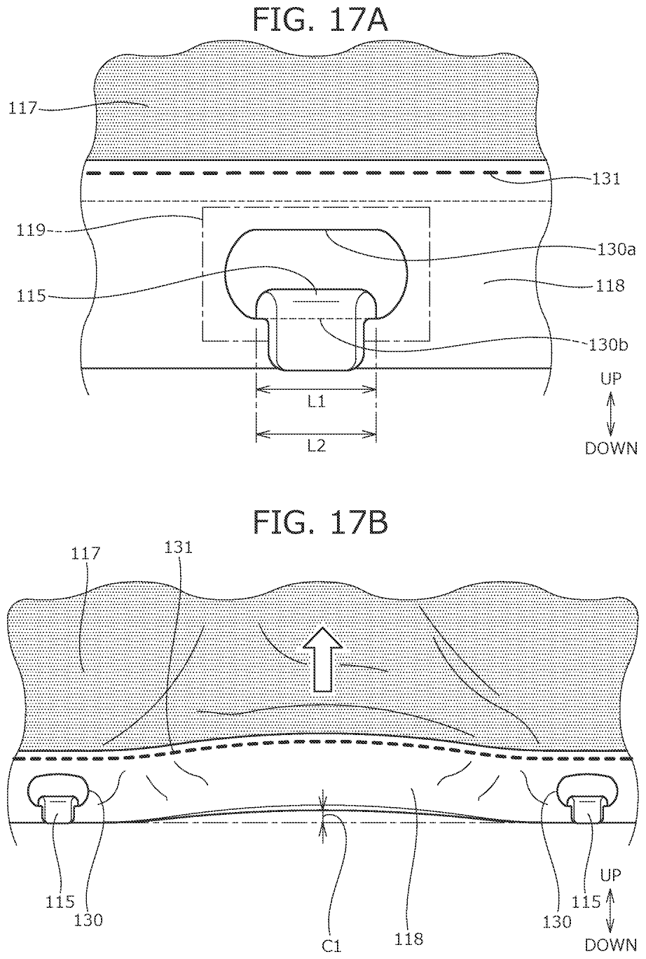

In the present embodiment, as shown in FIGS. 14 and 17A, each of the engaging portions 119 of the frame engaging members 118 is provided with an opening portion 130 penetrating therethrough. A size L2 of a lower side 130b of the opening portion 130 in the width direction is formed to be substantially the same size as a width L1 of the hook 115, the lower side 130b engaging with the hook 115.

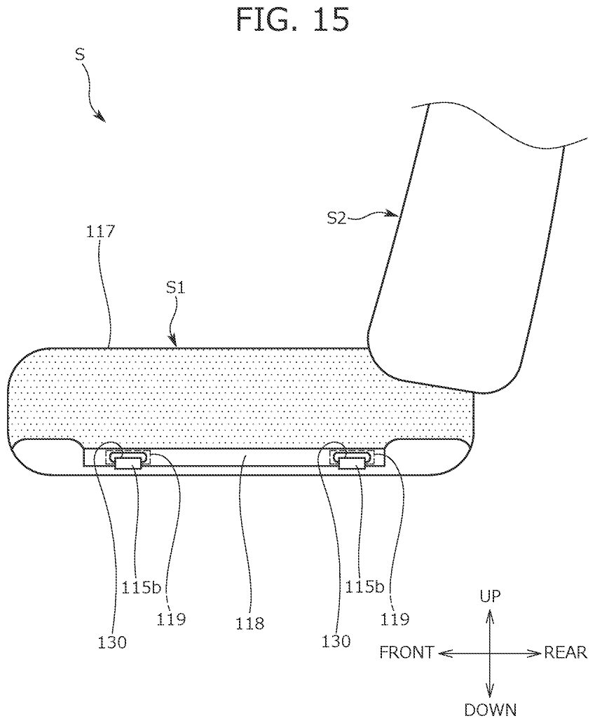

During assembly, for example, the cushion pad 116 is placed on the cushion frame 101 and then is covered with the trim cover 117, and the frame engaging member 118 in front of the cushion is hooked onto the hooks 115a of the pan frame 111. Next, as shown in FIG. 15, the frame engaging members 118 are hooked onto the hooks 115b of the cushion side frames 112.

As shown in FIG. 16, the extension portion 117b of the trim cover 117 is inserted into the gap V, together with the protruding portion 116a of the cushion pad 116, and the extension portion 117b is folded and the frame engaging member 118 provided at the end portion of the extension portion 117b is attached to the hooks 115c of the pressure receiving plate 114a of the frame F.

In such a manner, the trim cover 117 is attached to the cushion frame 101. In the related art, J-hooks or the like are used for attaching the plurality of hooks 115 one by one; however, since the frame engaging member 118 including the plurality of engaging portions 119 are hooked onto the plurality of hooks 115 at once, the trim cover 117 can be easily attached to the frame F.

### Shape of Engaging Portion

A shape of the opening portion 130 formed in the engaging portion 119 will be described with reference to FIGS. 17A to 19F.

As shown in FIG. 17A, the opening portion 130 is formed in each of the engaging portions 119 of the frame engaging members 118, as a laterally elongated through-hole. In a description based on the direction indicated in the drawing, the length of an upper side 130a and the lower side 130b (engagement side) of the opening portion 130 is substantially the same length as the length L2 of the hook 115 in the width direction. Both side portions of the engaging portion 119 are formed to draw curved lines. For this reason, the engaging portion 119 is formed in a shape in which a central portion in the up to down direction is slightly bulged, and the hook 115 can be easily inserted into the engaging portion 119. Incidentally, depending on the location where the hook 115 is disposed (for example, the hook 115a of the pan frame 111), the upper side 130a becomes a front side and the lower side 130b becomes a rear side.

### Another Example of Engaging Portion

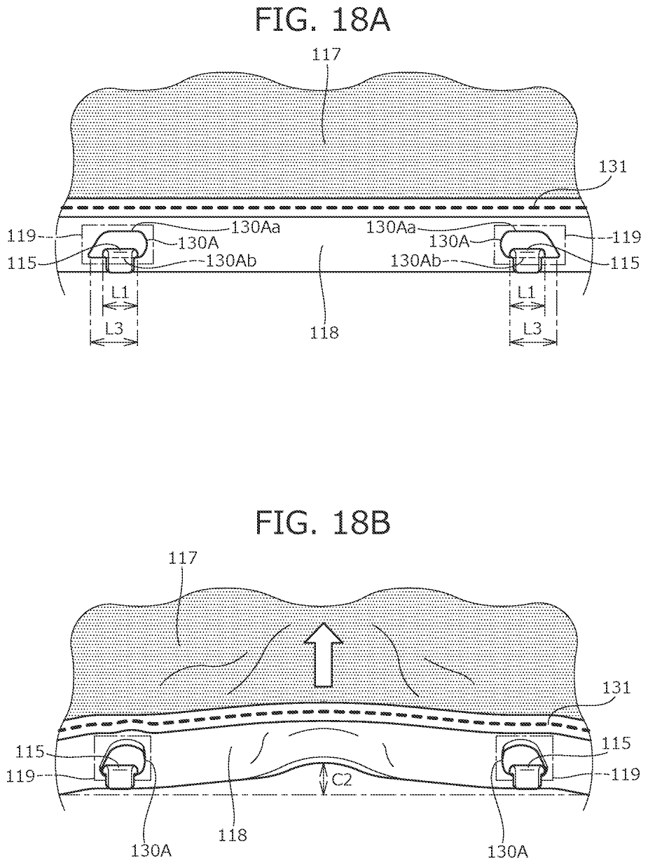

FIGS. 18A and 18B show an opening portion 130A that is another example of the opening portion 130. The opening portion 130A shown in FIG. 18A is also a laterally elongated through-hole formed in each of the engaging portions 119 of the frame engaging members 118. In a description based on the direction indicated in the drawing, in the opening portion 130A, the length L2 of an upper side 130Aa is substantially the same as the length L1 of the hook 115 in the width direction. On the other hand, a length L3 of a lower engagement side (lower side 130Ab) onto which the hook 115 directly hooks is formed to be larger than the length L1 of an engagement portion of the hook 115. In other words, the opening portion 130A is formed in a trapezoidal shape that partially protrudes in a direction along the end portion of the trim cover 117 (direction of arrow A). A so-called play portion can be created by setting the length of the lower side 130Ab of the opening portion to be larger than the length L1 of the hook 115 in the width direction. As shown in FIG. 18A, the play portion is formed on one side of the engagement portion with which the hook 115 engages. The play portions may be provided on both sides. The following effects are obtained due to the presence of the play portion.

When the occupant is seated on the seat cushion S1, as shown in FIG. 17B, the trim cover 117 may be pulled upward while following the buttocks of the occupant. As shown in FIG. 17A, in a case where the opening portion 130 into which the hook 115 is inserted is formed without a play portion provided, even when the trim cover 117 is pulled, a displacement amount C1 of the frame engaging member 118 is small, and the trim cover 117 is not significantly shifted. For this reason, when a stronger force is applied to the trim cover 117, there is a possibility that a connection portion 131 between the trim cover 117 and the frame engaging member 118 is damaged.

In a case where there is a play portion as in the opening portion 130A shown in FIG. 18A, when the trim cover 117 is pulled upward as shown in FIG. 18B, the trim cover 117 and the frame engaging member 118 are more significantly displaced compared to the case shown in FIG. 17B. Since a displacement amount C2 is large, the force applied to the connection portion 131 between the trim cover 117 and the frame engaging member 118 is weakened, so that damage can be suppressed. The size of the length L3 of the engagement side including the play portion is set depending on the desired size of the displacement amount C2, but is preferably approximately 1.2 to 2.0 times the length L1 of the hook 115 in the width direction, more preferably approximately 1.5 times.

### Modification Example of Opening Portion

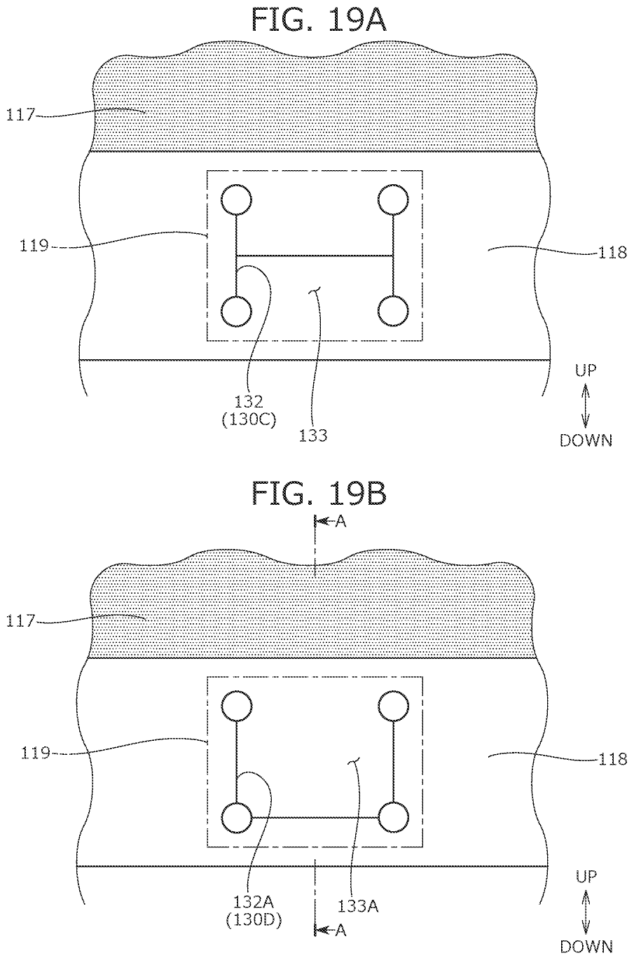

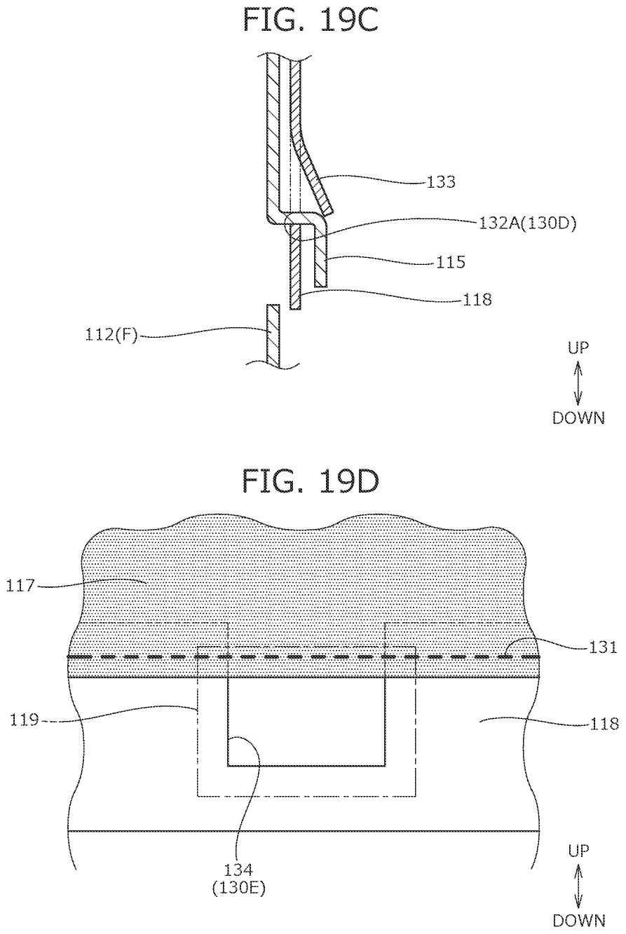

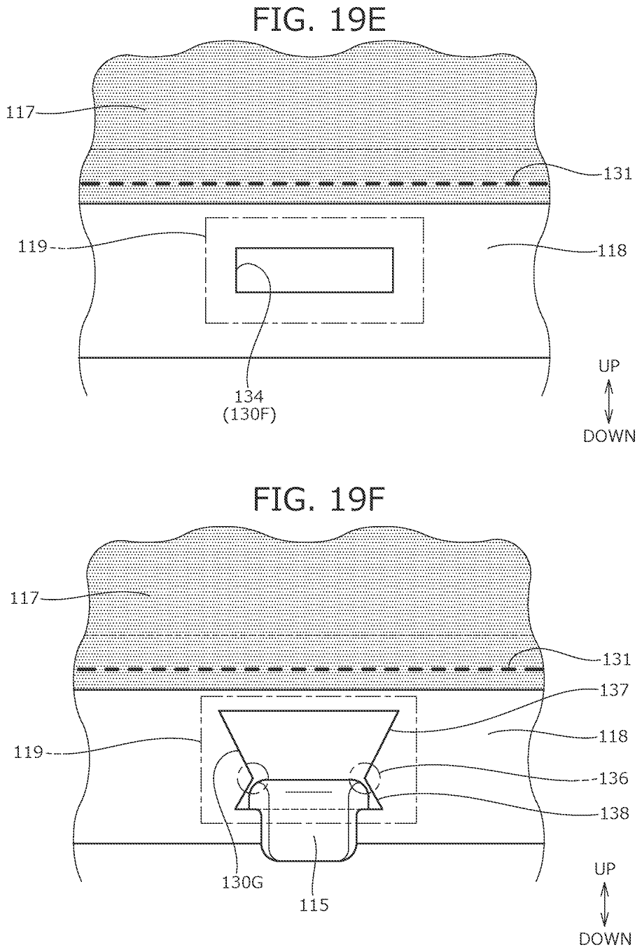

Modification examples of the opening portion 130 formed in the engaging portion 119 will be described with reference to FIGS. 19A to 19F. An opening portion 130C shown in FIG. 19A is formed by a slit 132 having an H shape. A tongue piece 133 formed by the slit 132 is flexed when the hook 115 is inserted, and the hook 115 can be inserted and engaged with the opening portion 130C.

In addition, an opening portion 130D shown in FIG. 19B is formed by a slit 132A having a U shape.

FIG. 19C shows a cross section along line A-A of FIG. 19B. By inserting the hook 115 into the opening portion 130D, a tongue piece 133A is flexed as shown in FIG. 19C, and the hook 115 engages with the opening portion 133D. As in the opening portion 130C or the opening portion 130D, since a through-hole is formed by the slit, the coming off of the hook 115 becomes difficult, and the intrusion of dust, debris or the like from the opening portion 130C or 130D can be suppressed.

An opening portion 130E formed in FIG. 19D is formed by a cutout 134 formed in the frame engaging member 118 and the end portion of the trim cover 117. An opening of the cutout 134 is closed by the end portion of the trim cover 117. In such a manner, a portion into which the hook 115 can be inserted may be formed in the opening portion 130E, and an engaging portion can be more easily formed.

In addition, as shown in FIG. 19E, an opening portion 130F may be formed by an elongated hole 135 extending along the end portion of the trim cover 117. Since the movement of the hook 115 in the up to down direction is suppressed, the hook 115 being inserted into the elongated hole 135, the coming off of the hook 115 is difficult.

In addition, as shown in FIG. 19F, throttle portions 136 protruding to the inside of an opening portion 130G may be provided on both lateral sides of the opening portion 130G. The throttle portions 136 are formed slightly below the center of the opening portion 130G in the up to down direction, in other words, in the vicinity of a lower side 130Gb onto which the hook 115 hooks.

In the opening portion 130G, a portion with a wide width (wide portion 137) and a portion with a narrow width (narrow portion 138) are formed. By inserting the hook 115 into the wide portion 137 and by placing the hook 115 into the narrow portion 138 over the throttle portions 136, the opening portion 130G from which the coming off of the hook 115 is difficult can be realized.

### Method for Attaching Frame Engaging Member

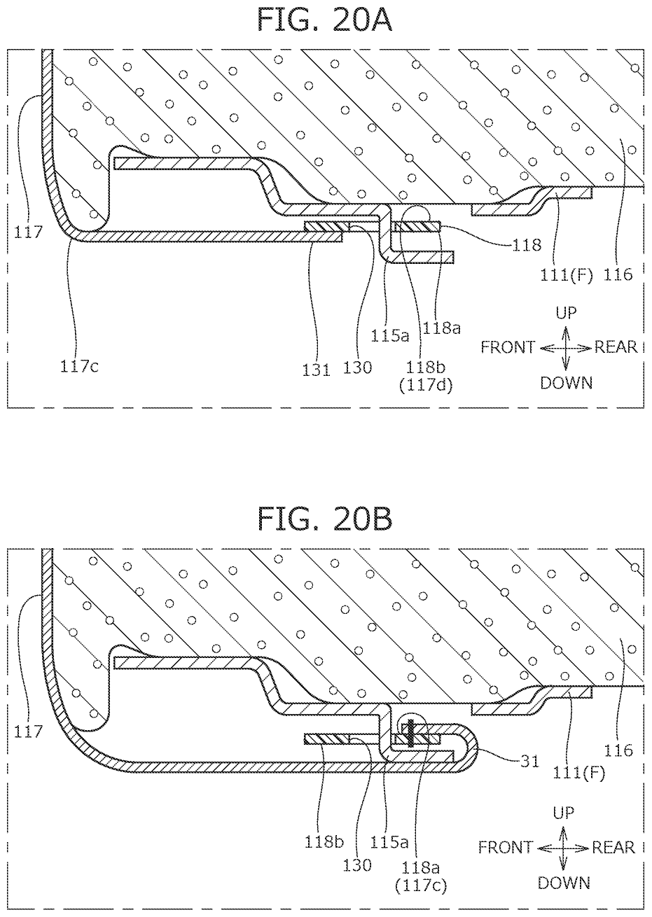

A method for attaching the frame engaging member 118 to the hook 115a will be described with reference to FIGS. 20A and 20B. FIGS. 20A and 20B are cross-sectional views along line XX-XX of FIG. 12.

FIG. 20A is a view showing the method in which the hook 115a is inserted and attached to the opening portion 130 from a back surface side 117d of the trim cover 117 (in more detail, a back surface side 118b of the frame engaging member 118).

As shown in FIG. 20A, when the hook 115a is inserted into the opening portion 130 from the back surface side 117d of the trim cover 117, the hook 115a is exposed. The attachment of the frame engaging member 18 is easy; however, the hook 115a is visible from the outside, which is a problem.

For this reason, in the attachment method shown in FIG. 20B, the hook 115a is attached such that the hook 115a is not exposed to the outside by covering the hook 115a with the trim cover 117. In a state where the hook 115a is inserted into the opening portion 130 from a surface side 117c of the trim cover 117 (in more detail, a surface side 118a of the frame engaging member 118) and the hook 115a (engaged portion) is engaged with the engaging portion 119, the trim cover 117 is folded to the opposite side at the connection portion 131 with the frame engaging member 118. Since the trim cover 117 is folded, as shown in FIG. 20B, the trim cover 117 covers the hook 115a.

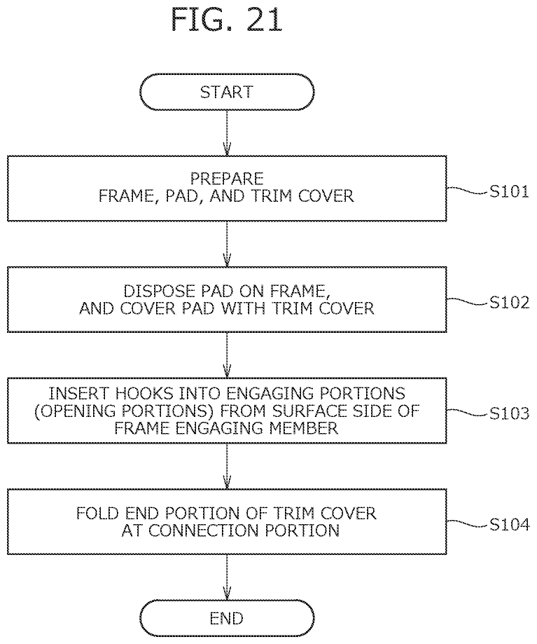

A method for manufacturing the vehicle seat S including the method for attaching the frame engaging member 118 shown in FIG. 20B will be described with reference to FIG. 21. It is assumed that the frame F shown in FIG. 12 is prepared in advance, the back pad 126 is disposed on the frame F, and the back trim cover 127 covering the back pad 126 is attached. Then, the cushion pad 116 and the trim cover 117 constituting the seat cushion S1 is prepared (step S101).

The cushion pad 116 is disposed on the frame F, and the cushion pad 116 is covered with the trim cover 117 (step S102).

Then, the hooks 115a provided on the frame F are inserted into the engaging portions 119 (in more detail, the opening portions 130) of the frame engaging member 118 provided at the end portion of the trim cover 117, from the surface side 118a of the frame engaging member 118 (surface side of the skin), and the engaging portions 119 and the hooks 115 are engaged with each other (step S103).

After the hooks 115a are engaged with the engaging portions 119, the end portion of the trim cover 117 is folded at the connection portion 131 with the frame engaging member 118, and the trim cover 117 is disposed such that the hooks 115 are covered with the trim cover 117 (step S104).

A predetermined tension is applied by hooking the frame engaging member 118 onto the hooks 115a, and the trim cover 117 is attached to the cushion pad 116.

In addition, since the frame engaging member 118 is attached to the hooks 115a in such a manner, the hooks 115 are not exposed and are not visually recognized from the outside, so that the design appeal of the vehicle seat S is improved.

Incidentally, in the attachment method, the hooks 115a have been described as an example; however, the trim covers 117 can also be attached to the hooks 115b and 115c using the same method.

### Another Example of Frame Engaging Member

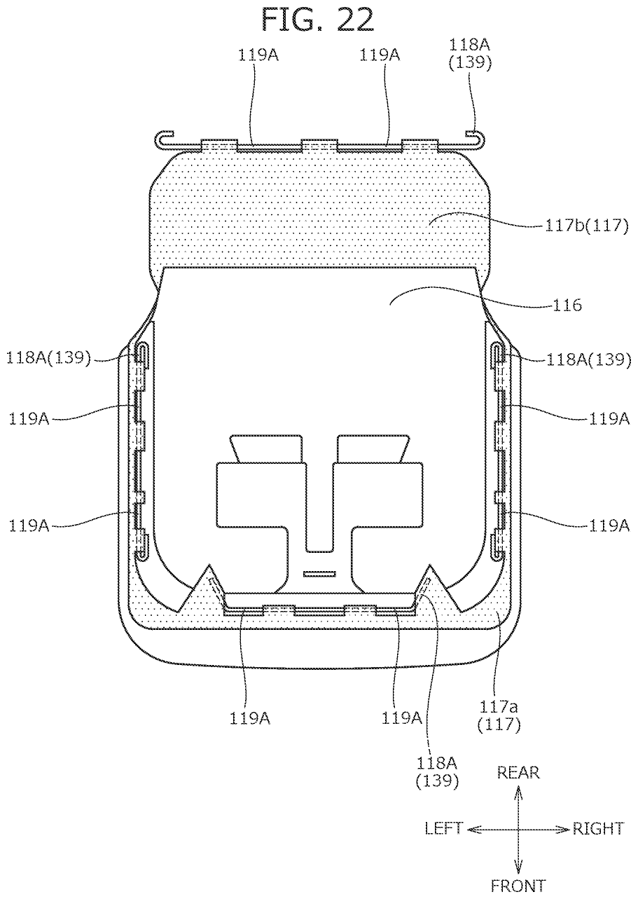

Plate-shaped plate members are attached to the end portions of the cushion trim cover 117 shown in FIG. 14, as the frame engaging members 118. The frame engaging members 118 are not limited to the plate-shaped plate members, and for example, as in frame engaging members 118A shown in FIG. 22, the frame engaging members may be realized by wire members 139 having a wire shape. The wire members 139 are attached along the end portions of the trim cover 117.

The wire members 139 are passed through and housed in bag-shaped portions formed by folding and stitching the end portions of the trim cover 117. Then, engaging portions 119A that expose portions of the wire members 139 are formed by cutting out portions of the trim cover 117. The exposed wire members 139 (engaging portions 119A) are hooked onto the hooks 115. Since a predetermined tension is applied, the cushion trim cover 117 is fixed to the cushion pad 116.

It is preferable that metal or resin wires having a rod shape, a wire shape, a tube shape, or the like are used as the wire members 139. In addition, the diameter of the wire members 139 is preferably 1 to 8 mm, more preferably 1.5 to 5 mm.

The conveyance seat and the manufacturing method thereof according to the second embodiment have been described above with reference to the drawings. In the embodiment, the trim cover 117 used for the seat cushion S1 has been described as an example; however, the embodiment is one example, and the present invention may be applied to the seat back S2. Namely, in the seat back S2, frame engaging members may be provided in and attached to the trim cover 127 for a back pad covering the back pad 126. Since engaging portions corresponding to a plurality of hooks provided on the back frame 102 are collectively attached, workability when assembling the back pad 126 is improved.

Further supplementary notes regarding the disclosed second embodiment will be given as follows.

### Supplementary Note 1

There is provided a conveyance seat including: a frame; a pad disposed on the frame; and a skin covering the pad. The skin includes a frame engaging member that engages with the frame, at an end portion of the skin. A plurality of engaging portions are formed in the frame engaging member. A plurality of engaged portions corresponding to the plurality of engaging portions are provided on the frame.

### Supplementary Note 2

In the conveyance seat according to Supplementary Note 1, each of the plurality of engaged portions is formed of an L-shaped hook integrally formed with the frame.

### Supplementary Note 3

In the conveyance seat according to Supplementary Note 1 or 2, the frame engaging member is a plate-shaped plate member attached along the end portion of the skin.

### Supplementary Note 4

In the conveyance seat according to Supplementary Note 3, the plurality of engaging portions include respective opening portions into which the engaged portions are inserted, and the opening portions are formed side by side along the end portion of the skin in the vicinity of an end portion of the plate member.

### Supplementary Note 5

In the conveyance seat according to Supplementary Note 4, the opening portions are formed in a trapezoidal shape.

### Supplementary Note 6

In the conveyance seat according to Supplementary Note 4, the opening portions are formed by slits having an H shape or a U shape.

### Supplementary Note 7

In the conveyance seat according to Supplementary Note 4, the opening portions are formed by cutouts formed in the plate member and the end portion of the skin, which closes openings of the cutouts.

### Supplementary Note 8

In the conveyance seat according to Supplementary Note 4, throttle portions protruding toward insides of the opening portions are provided at side portions of the opening portions.

### Supplementary Note 9

In the conveyance seat according to any one of Supplementary Notes 4 to 8, a length of engagement sides of the opening portions, which engage with the engaged portions, are formed to be larger than a length of portions where the engaged portions engage with the engaging portions.

### Supplementary Note 10

In the conveyance seat according to Supplementary Note 1 or 2, the frame engaging member is a wire member attached along the end portion of the skin, and portions of the wire member exposed by cutouts formed at the end portion of the skin engage with the engaged portions provided on the frame.

### Supplementary Note 11

There is provided a conveyance seat including: a frame; a pad disposed on the frame; and a skin covering the pad. The skin includes a frame engaging member that engages with the frame, at an end portion of the skin. An engaging portion is formed in the frame engaging member. An engaged portion corresponding to the engaging portion is provided on the frame. The frame engaging member is a plate-shaped plate member attached along the end portion of the skin. The engaging portion includes an opening portion into which the engaged portion is inserted. A length of an engagement side of the opening portion, which engages with the engaged portion, is formed to be larger than a length of a portion where the engaged portion engages with the engaging portion.

### Supplementary Note 12

In the conveyance seat according to Supplementary Note 11, the engaged portion is formed of an L-shaped hook integrally formed with the frame.

### Supplementary Note 13

In the conveyance seat according to Supplementary Note 11 or 12, a plurality of the engaging portions are formed in the frame engaging member, and a plurality of the engaged portions are provided to correspond to the plurality of engaging portions.

### Supplementary Note 14

In the conveyance seat according to any one of Supplementary Notes 11 to 13, the length of the engagement side of the opening portion, which engages with the engaged portion, is 1.2 to 2.0 times the length of the portion where the engaged portion engages with the engaging portion.

### Supplementary Note 15

In the conveyance seat according to any one of Supplementary Notes 11 to 14, the opening portion is formed in a trapezoidal shape.

### Supplementary Note 16

In the conveyance seat according to any one of Supplementary Notes 11 to 14, the opening portion is formed by a slit having an H shape or a U shape.

### Supplementary Note 17

In the conveyance seat according to any one of Supplementary Notes 11 to 14, the opening portion is formed by a cutout formed in the frame engaging member and the end portion of the skin, which closes an opening of the cutout.

### Supplementary Note 18

In the conveyance seat according to any one of Supplementary Notes 11 to 14, a throttle portion protruding toward an inside of the opening portion is provided at a side portion of the opening portion.

### Supplementary Note 19

In the conveyance seat according to any one of Supplementary Notes 11 to 14, the opening portion is an elongated hole extending along the end portion of the skin.

### Supplementary Note 20

In the conveyance seat according to any one of Supplementary Notes 11 to 19, the engaged portion is inserted into the opening portion from a surface side of the frame engaging member, and in a state where the engaging portion and the engaged portion are engaged with each other, the skin is folded at a connection portion with the frame engaging member, and is disposed such that the engaged portion is covered with the skin.

### Supplementary Note 21

There is provided a conveyance seat including: a frame; a pad disposed on the frame; and a skin covering the pad. The skin includes a frame engaging member that engages with the frame, at an end portion of the skin. An engaging portion is formed in the frame engaging member. An engaged portion corresponding to the engaging portion is provided on the frame. The engaged portion is engaged from a surface side of the frame engaging member. In a state where the engaging portion and the engaged portion are engaged with each other, the skin is folded at a connection portion with the frame engaging member, and is disposed such that the engaged portion is covered with the skin.

### Supplementary Note 22

In the conveyance seat according to Supplementary Note 21, the engaged portion is formed of an L-shaped hook integrally formed with the frame.

### Supplementary Note 23

In the conveyance seat according to Supplementary Note 21 or 22, the frame engaging member is a plate-shaped plate member attached along the end portion of the skin, and the engaging portion includes an opening portion into which the engaged portion is inserted.

### Supplementary Note 24

In the conveyance seat according to Supplementary Note 23, a length of an engagement side of the opening portion, which engages with the engaged portion, is formed to be larger than a length of a portion where the engaged portion engages with the engaging portion.

### Supplementary Note 25

In the conveyance seat according to Supplementary Note 23 or 24, the opening portion is formed in a trapezoidal shape.

### Supplementary Note 26

In the conveyance seat according to any one of Supplementary Notes 23 to 25, the opening portion is formed by a slit having an H shape or a U shape.

### Supplementary Note 27

In the conveyance seat according to any one of Supplementary Notes 23 to 25, the opening portion is formed by a cutout formed in the frame engaging member and the end portion of the skin, which closes an opening of the cutout.

### Supplementary Note 28

In the conveyance seat according to any one of Supplementary Notes 23 to 25, a throttle portion protruding toward an inside of the opening portion is provided at a side portion of the opening portion.

### Supplementary Note 29

In the conveyance seat according to any one of Supplementary Notes 23 to 25, the opening portion is an elongated hole extending along the end portion of the skin.

### Supplementary Note 30

There is provided a method for manufacturing a conveyance seat, the method including: a step of preparing a frame, a pad, and a skin covering the pad; a step of disposing the pad on the frame and covering the pad with the skin; a step of engaging an engaged portion that is provided on the frame to correspond to an engaging portion of a frame engaging member that is provided at an end portion of the skin to engage with the frame, with the engaging portion from a surface side of the skin; and a step of folding the end portion of the skin at a connection portion with the frame engaging member and covering the engaged portion with the skin.

### REFERENCE SIGNS LIST

D: vehicle door

P: door panel

Pa: pad

1: armrest (interior component for conveyance)

1a: upper surface

1b: side surface

1c: front end

1d: rear end

1e: intersection portion

2: design surface

3: boss

4: point-shaped locking portion

5: linear locking member

6, 6A, 6B: engaging portion

10: base material

10a: surface

10b: back surface

11a, 11b: upper terminal portion (first terminal portion)

12a, 12b: lower terminal portion (second terminal portion)

15: stitch (design line)

20: skin material

21: upper end portion

22: lower end portion

23: sewing portion

30, 30A: suspender cord (first linear locking member)

30B, 30C: trim cord (first linear locking member)

31: hook portion (engaging portion)

31a: return portion

32: holding portion

33: nonwoven fabric

34, 34A: through-hole

35: recess

40: trim cord (second linear locking member)

41: locking claw (engaging portion)

46: rib

50: door lining

51: upper member

52: center member

53: lower member

54: door handle

55: opening and closing switch

56: door pocket

S: vehicle seat (conveyance seat)

S1: seat cushion

S2: seat back

S3: headrest

F: frame

101: cushion frame (frame)

102: back frame (frame)

111: pan frame

112: cushion side frame

113a: front pipe

113b: rear pipe

114: spring

114a: pressure receiving plate

115, 115a, 115b, 115c: hook (engaged portion)

116: cushion pad (pad)

116a: protruding portion

117: trim cover (skin)

117a: cover body

117b: extension portion

117c: surface side

117d: back surface side

118, 118A: frame engaging member

118a: surface side

118b: back surface side

119, 119A: engaging portion

121: upper frame

121a: headrest guide

122: back side frame

123: lower frame

124: pressure receiving plate

126: back pad

127: trim cover

130, 130A to 130G: opening portion

131: connection portion

132: slit

133: tongue piece

134: cutout

135: elongated hole

136: throttle portion

137: wide portion

138: narrow portion

139: wire member

160: reclining mechanism

161: headrest pillar

1. An interior component for a conveyance having a design surface, comprising:
a base material; and
a skin material covering the base material,
wherein the skin material includes a linear locking member at an end portion of the skin material, and
the linear locking member is attached at a position that is not visible from a design surface side of the base material.

2. The interior component for a conveyance according to claim 1,
wherein the linear locking member is formed in a rod shape or an elongated plate shape.

3. The interior component for a conveyance according to claim 1,
wherein a plurality of the linear locking members are provided, and the linear locking member includes a first linear locking member attached to a first terminal portion of the base material, and a second linear locking member attached to a second terminal portion of the base material, the second terminal portion being located opposite to the first terminal portion.

4. The interior component for a conveyance according to claim 3,
wherein the first linear locking member and the second linear locking member are disposed to be separated from each other as the first linear locking member and the second linear locking member extend from an end portion toward a center of the base material.

5. The interior component for a conveyance according to claim 3,
wherein the first linear locking member is attached to the first terminal portion on an upper side of the base material, the second linear locking member is attached to the second terminal portion on a lower side of the base material, and the second linear locking member is longer than the first linear locking member.

6. The interior component for a conveyance according to claim 3,
wherein the first linear locking member is attached to the first terminal portion on an upper side of the base material, and the second linear locking member is attached to the second terminal portion on a lower side of the base material, and
the skin material has a design line between the first linear locking member and the second linear locking member.

7. The interior component for a conveyance according to claim 1,
wherein the base material includes an engaging portion that engages with the linear locking member on a back side of a terminal portion.

8. The interior component for a conveyance according to claim 7,
wherein the base material includes a point-shaped locking portion that locks the skin material on the back side of the terminal portion in addition to the engaging portion.

9. The interior component for a conveyance according to claim 7,
wherein a through-hole is formed in the vicinity of the terminal portion of the skin material,
the engaging portion includes a hook portion that is hooked onto the linear locking member, and
the linear locking member is attached to the base material by being hooked onto the hook portion inserted into the through-hole.

10. The interior component for a conveyance according to claim 7,
wherein the engaging portion includes a locking claw that locks the linear locking member,
the linear locking member is formed in an elongated plate shape, and
the linear locking member is attached to the base material by being disposed on a back surface side of the base material and by engaging with the locking claw.
